(19) United States
(12) Patent Application Publication
(10) Pub. No.: US 2026/0289463 A1
(43) Pub. Date: Sep. 24, 2026

(54) SYSTEM

(71) Applicant: SoftBank Group Corp., Tokyo (JP)

(72) Inventor: Shoya KUSUNOSE, Tokyo (JP)

(73) Assignee: SoftBank Group Corp., Tokyo (JP)

(21) Appl. No.: 19/567,070

(22) Filed: Mar. 14, 2026

(30) Foreign Application Priority Data
Mar. 19, 2025 (JP) 2025-045238

(51) Int. Cl. G06Q 10/0635; G06F 16/215; G06N 3/0475

(52) U.S. Cl. CPC G06Q 10/0635; G06F 16/215; G06N 3/0475

(57) ABSTRACT

A system includes a processor that is configured to receive text information from a user via an interface for receiving text information, detect, by using a natural language processing technique, specific expressions included in the received text information, analyze, by a statistical method, occurrence frequencies of the detected specific expressions to calculate a funniness level, analyze, by using a machine learning algorithm, an emotion of the user in order to perform emotion analysis, and generate a prompt for instructing a generative AI model to generate specific visual feedback based on the calculated funniness level and a result of the emotion analysis.

### CROSS-REFERENCE TO RELATED APPLICATION

This application is based on and claims priority under 35 USC 119 from Japanese Patent Application No. 2025-045238 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for analyzing user-generated text typically rely on simple keyword counts or rudimentary sentiment analysis to infer user reactions, such as whether content is funny or emotionally engaging. Such systems suffer from several drawbacks. First, they do not robustly capture nuanced expressions of humor, including culture-specific or context-dependent expressions, and therefore provide inaccurate or overly coarse “funniness” evaluations. Second, existing approaches generally separate text-based humor detection from user emotion analysis, resulting in feedback that does not adequately reflect the combined effect of linguistic cues and the user's emotional state. Third, current systems provide limited or static visual feedback that fails to leverage advanced generative AI models, and thus cannot dynamically adapt visual elements to the inferred funniness level and emotional context in real time. Consequently, there is a need for a system that can (i) detect specific expressions within user text using natural language processing, (ii) evaluate the funniness level by statistically and probabilistically analyzing expression frequencies in conjunction with a model of general perception of funniness, (iii) incorporate machine-learning-based emotion analysis of the user, and (iv) generate prompts that direct a generative AI model to produce specific and dynamically adjusted visual feedback, thereby providing the user with real-time, intuitive, and contextually appropriate feedback.

### SUMMARY

To solve the above problems, the present invention provides a system comprising a processor configured to perform a series of coordinated operations. The processor receives text information from a user via an interface for receiving text information. The processor applies a natural language processing technique to the received text information to detect specific expressions, such as laughter indicators or other expressions associated with humor or reactions. The processor analyzes occurrence frequencies of the detected specific expressions by a statistical method to calculate a funniness level. In addition, the processor uses a machine learning algorithm to analyze the emotion of the user in order to obtain an emotion analysis result corresponding to the text information or the user's current state. Based on the calculated funniness level and the emotion analysis result, the processor generates a prompt configured to instruct a generative AI model to generate specific visual feedback. In one embodiment, the processor evaluates the occurrence frequencies of the specific expressions by Bayesian estimation, retrieves from a database information representing a general perception of funniness associated with the specific expressions, compares the retrieved information with the evaluated occurrence frequencies, and calculates the funniness level by weighting the emotion analysis result of the user in combination with the comparison. In another embodiment, the processor generates a prompt that instructs the generative AI model to dynamically adjust visual elements according to the funniness level and the emotion analysis result, and provides feedback to the user in real time based on output from the generative AI model. Through these means, the system achieves integrated, accurate evaluation of funniness and emotion, and delivers adaptive, real-time visual feedback to the user.

The term “processor” refers to a hardware processing unit or a combination of hardware and software components, such as a CPU, GPU, or dedicated processing circuitry, that executes instructions to perform the functions described in the claims, including text reception, natural language processing, statistical analysis, machine learning-based emotion analysis, and prompt generation.

The term “text information” refers to information expressed in natural language characters, symbols, or strings, including but not limited to sentences, phrases, posts, comments, or messages input by a user or obtained from an external source, which is subject to analysis by the processor.

The term “interface for receiving text information” refers to a hardware and/or software interface, such as a graphical user interface, input form, API endpoint, or communication module, through which text information from a user or an external system is input to the processor.

The term “natural language processing technique” refers to a computational method or algorithm for analyzing and processing natural language text, including tokenization, morphological analysis, syntactic analysis, semantic analysis, pattern matching, or other linguistic processing used to detect specific expressions in text information.

The term “specific expressions” refers to predetermined words, symbols, character sequences, or linguistic patterns appearing in text information that are associated with humor, laughter, reactions, or other target phenomena, and whose occurrences are detected and analyzed by the processor.

The term “occurrence frequency” refers to a quantitative measure of how many times a specific expression appears within a given body of text information, which is used by the processor as a basis for calculating a funniness level.

The term “statistical method” refers to a mathematical technique or procedure, including but not limited to counting, frequency analysis, probabilistic modeling, or other statistical analysis, used by the processor to analyze the occurrence frequencies of specific expressions and derive a funniness level.

The term “funniness level” refers to a numerical or categorical value calculated by the processor, representing an estimated degree of humor or comedic effect in the text information, based on occurrence frequencies of specific expressions and, in some embodiments, on emotion analysis results and general perception data.

The term “machine learning algorithm” refers to an algorithm or model, such as a neural network, support vector machine, decision tree, or other learning-based model, that is trained on data to infer patterns and is used by the processor to perform emotion analysis on user-related information.

The term “emotion analysis” refers to a process in which the processor, by using a machine learning algorithm, estimates or classifies a user's emotional state (for example, happiness, amusement, surprise, or other emotions) based on text information, user behavior, biometric data, or other relevant input.

The term “emotion analysis result” refers to an output of the emotion analysis, including a label, score, distribution, or other representation indicating the estimated emotional state or intensity of the user.

The term “prompt” refers to a structured text, parameter set, control signal, or other instruction data generated by the processor and provided as input to a generative AI model, specifying how the generative AI model should generate or modify visual feedback.

The term “generative AI model” refers to an artificial intelligence model capable of generating new content, including images, animations, or other visual elements, based on input prompts, such as a generative adversarial network, diffusion model, transformer-based model, or other content generation architecture.

The term “visual feedback” refers to output generated by the generative AI model in response to a prompt, including images, graphics, animations, or other visual elements, which are presented to the user to reflect or represent the funniness level and the emotion analysis result.

The term “Bayesian estimation” refers to a probabilistic estimation technique based on Bayes'theorem, in which the processor updates probability distributions or parameter estimates for occurrence frequencies or funniness-related metrics using prior information and observed data.

The term “database” refers to a structured data storage system, implemented in hardware and/or software, that stores information such as mappings between specific expressions and general perceptions of funniness, which can be retrieved and referenced by the processor during analysis.

The term “general perception of funniness” refers to information representing a statistically or empirically derived association between specific expressions and perceived humor levels in a population or user group, stored in the database and used by the processor as reference data.

The term “dynamically adjust visual elements” refers to the operation in which the processor, through the prompt, causes the generative AI model to change visual properties, such as color, layout, density, size, motion, or composition of visual components, in real time or near real time, in accordance with the funniness level and emotion analysis result.

The term “real time” refers to a response manner in which feedback is provided to the user with a latency sufficiently short that the user perceives the feedback as substantially immediate or contemporaneous with the input or interaction, within system-dependent processing constraints.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

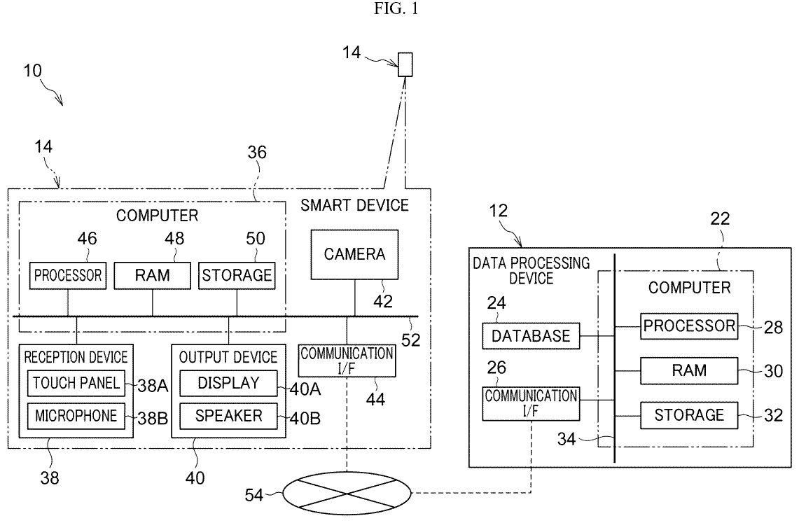

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

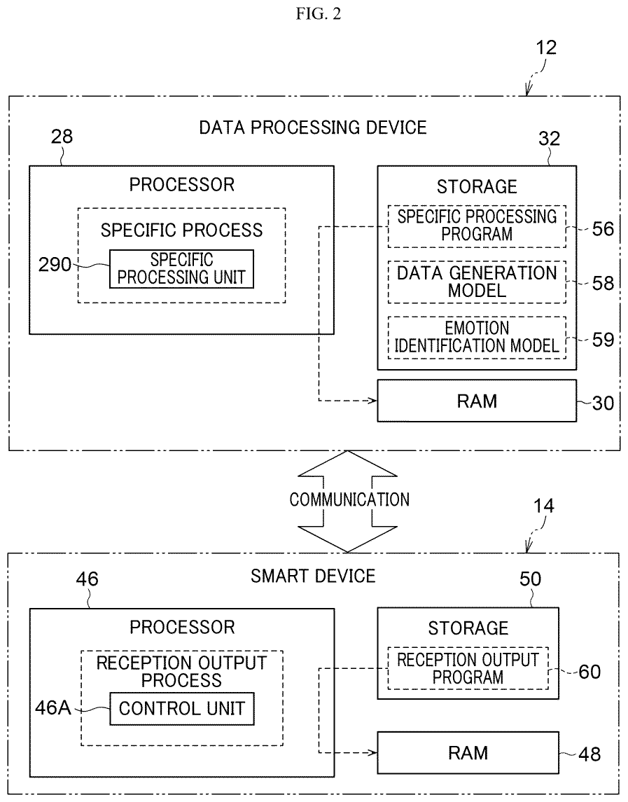

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In recent years, network-based information environments have produced a rapidly increasing volume of text content such as social media posts, network articles, and various forms of structured and semi-structured documents. While generative AI models have become capable of producing sophisticated outputs, the quality and reliability of those outputs depend heavily on the quality of the prompt sentences provided to the models. In practical use, a human user must manually search for relevant information sources, read through large amounts of text, identify important topics and perspectives, and then manually craft an appropriate prompt sentence. This manual workflow is time-consuming, cognitively demanding, and prone to inconsistency and omission of important context.

Conventional computer systems that assist prompt creation generally focus on simple keyword extraction or static templates and treat the prompt as a superficial text string, rather than as a structured, information-rich interface between the collected data and the generative AI model. Such systems do not effectively integrate heterogeneous sources (for example, web pages and social media posts), do not robustly perform multi-step linguistic and statistical analysis, and do not automatically translate those analysis results into prompt sentences that are tailored to different request types, topics, and target reader attributes. As a result, conventional systems fail to improve the underlying computer functionality for information collection and analysis, and they largely rely on human users to bridge the gap between raw text data and effective communication with generative AI models.

Further, typical information retrieval systems and summarization tools are not configured as an end-to-end pipeline that starts from user-specified source conditions, automatically collects and normalizes text from multiple remote information-providing devices, performs structured natural language processing including vectorization and statistical scoring, and then generates multiple categorized prompt sentence candidates suitable for direct input into a generative AI model. Such systems often require separate applications or manual copying and pasting between tools, which introduces latency, user error, and inefficient utilization of processing resources.

Accordingly, there is a need for an improved computer system that integrates network-based data collection, natural language processing, and prompt generation in a unified architecture, so that the processor itself can automatically transform heterogeneous text streams into structured topic information and optimized prompt sentences. By doing so, the system should reduce computational redundancy, improve the efficiency and consistency of text analysis and prompt formation, and enhance the overall operation of computers when they are used to prepare inputs for generative AI models.

The specific processing by the specific processing unit 290 of the data processing device 12 in Example 1 is realized by the following means.

The present invention provides a server comprising a processor configured to receive, via an interface with a terminal including a display device and an input device, text information including source conditions from a user; to acquire, based on the source conditions and via an information communication network, structured document data and posting data from a plurality of information providing devices, to extract standardized text data from the structured document data, and to integrate the standardized text data with the posting data and text data directly input by the user to generate analysis target text data; to perform natural language processing on the analysis target text data, the natural language processing including morphological analysis, phrase segmentation, vectorization and statistical quantity calculation, to extract important phrases and important sentences and to generate summary information of the analysis target text data; to determine abstract topic information representing a content of a subject and a target reader attribute based on the important phrases and the summary information, to hierarchically classify the topic information based on a set of important phrases including compound phrases, and to automatically generate at least one prompt sentence for input to a generative AI model by using a plurality of template sentence patterns categorized into at least an explanation request type, a summarization request type, a comparison request type, and a risk analysis request type, the template sentence patterns including the topic information and being selected in accordance with an occurrence tendency of the important phrases; and to transmit the summary information, the important phrases, and a group of candidate prompt sentences to the terminal so that the terminal visually presents the summary information, the important phrases, and the candidate prompt sentences to the user and allows the user to select and edit the candidate prompt sentences. This enables a computer-implemented pipeline in which heterogeneous textual data from networked sources are automatically normalized, analyzed, and transformed into structured topic representations and tailored prompt sentences, thereby improving the efficiency, reliability, and functional capability of the computer system in generating high-quality prompts for generative AI models and reducing the manual effort and cognitive load required from the user.

The term “processor” refers to a hardware-implemented information processing unit, such as a central processing unit or other computing circuitry, that executes machine-readable instructions to perform the functions described in the system.

The term “terminal” refers to an information processing device including at least a display device and an input device, such as a client computer, a mobile device, or a similar user interface device, used by a user to interact with the server.

The term “display device” refers to a visual output component of the terminal, such as a monitor, a touch screen, or another graphical display unit, that presents information to the user.

The term “input device” refers to a user interface component of the terminal, such as a keyboard, a pointing device, a touch panel, or a similar input unit, that receives operations or text input from the user.

The term “text information” refers to information represented as character strings or symbolic sequences, including but not limited to sentences, paragraphs, and other textual content provided by the user or obtained from external sources.

The term “source conditions” refers to user-specified parameters that define one or more information sources to be collected, such as network locations, account identifiers, keywords, or time ranges.

The term “information communication network” refers to a communication infrastructure, such as a packet-based digital network, that enables data transmission between the server and a plurality of external devices.

The term “information providing device” refers to a remote computing device or service, such as a server or an online service system, that provides structured document data or posting data via the information communication network.

The term “structured document data” refers to document information represented in a structured or semi-structured markup or data format, such as hypertext data or markup-based document data, from which text segments can be programmatically extracted.

The term “posting data” refers to short-form or long-form message data, such as social media posts, microblog entries, or similar user-generated content items obtained from a communication service.

The term “standardized text data” refers to text data that has been normalized from structured document data by processing such as tag removal, character normalization, or format unification to generate a consistent textual representation.

The term “analysis target text data” refers to a unified text dataset generated by integrating standardized text data, posting data, and user-input text, which serves as an input to subsequent natural language processing.

The term “natural language processing” refers to a set of computational techniques for analyzing and transforming human language text, including at least morphological analysis, phrase segmentation, vectorization, and statistical quantity calculation.

The term “morphological analysis” refers to a process of decomposing text into minimal linguistic units, such as words or morphemes, and assigning linguistic attributes such as part-of-speech or base form to each unit.

The term “phrase segmentation” refers to a process of dividing text into meaningful multi-word units, such as phrases or segments, based on syntactic, lexical, or statistical criteria.

The term “vectorization” refers to a process of converting text data, such as documents or phrases, into numerical vector representations suitable for computational analysis, such as similarity computation or statistical modeling.

The term “statistical quantity calculation” refers to a computation process that derives numerical measures from text data, such as frequency counts, weighting scores, or other statistical indicators for units like words, phrases, or documents.

The term “important phrase” refers to a phrase selected from the analysis target text data based on one or more statistical or linguistic criteria indicating that the phrase has a higher relevance or significance relative to other phrases.

The term “important sentence” refers to a sentence selected from the analysis target text data based on one or more statistical, semantic, or structural criteria indicating that the sentence is representative or informative for summarization.

The term “summary information” refers to condensed textual information derived from the analysis target text data, including at least one important sentence or a set of representative expressions that collectively describe main points of the original data.

The term “topic information” refers to abstract information indicating a subject content and, optionally, a related target reader attribute, derived from important phrases and summary information by classification or grouping.

The term “target reader attribute” refers to information that characterizes an intended recipient of generated content, such as a level of expertise, a role category, or a domain interest of the reader.

The term “compound phrase” refers to a multi-word phrase, such as a noun phrase or a collocation, treated as a single semantic unit for analysis and scoring.

The term “hierarchical classification” refers to an operation of organizing topic information or phrases into a multi-level structure, such as categories and subcategories, based on similarities or relationships among them.

The term “template sentence pattern” refers to a sentence structure including one or more placeholders, which are filled with topic information or other parameters to automatically generate a specific prompt sentence.

The term “prompt sentence” refers to a natural language instruction, query, or request text provided as an input to a generative AI model to control or guide the content of the model's output.

The term “generative AI model” refers to a machine learning model, such as a probabilistic or neural network-based model, capable of generating new content including text, images, or other media in response to input data such as prompt sentences.

The term “explanation request type” refers to a category of prompt sentence that instructs a generative AI model to provide an explanatory output for a concept, event, or topic.

The term “summarization request type” refers to a category of prompt sentence that instructs a generative AI model to generate a condensed representation of input content, focusing on main points or key information.

The term “comparison request type” refers to a category of prompt sentence that instructs a generative AI model to compare two or more items, topics, or conditions and explain similarities, differences, or relative characteristics.

The term “risk analysis request type” refers to a category of prompt sentence that instructs a generative AI model to identify, evaluate, or discuss risks, issues, or potential negative outcomes related to a given topic.

The term “candidate prompt sentence” refers to a prompt sentence that has been automatically generated by the processor and is presented to the user as an option for selection or editing.

The term “occurrence tendency” refers to a statistical tendency relating to how often important phrases or other textual features appear in the analysis target text data, including distribution patterns or co-occurrence relationships.

The term “group of candidate prompt sentences” refers to a plurality of prompt sentences generated for a given analysis target text data, which are provided to the user so that the user can choose or modify one or more of them.

In one embodiment, a server cooperates with a terminal operated by a user to implement the claimed system. The server includes at least one processor, a main memory, a nonvolatile storage device, and a network interface, and is connected to an information communication network such as a packet-based digital network. The terminal includes at least a display device, an input device, a local processor, a local memory, and a communication interface. The server executes an operating system such as a general-purpose server operating system and a middleware stack including a web server, an application framework, and a database management system. The server further executes application modules implementing data collection, natural language processing, topic determination, and prompt sentence generation.

The server uses a storage device to maintain a plurality of data structures. For example, the server stores a request table that associates a request identifier with user-specified source conditions, a source document table that stores structured document data and posting data obtained from external information providing devices, a normalized text table that stores standardized text data generated from the structured document data, an analysis corpus table that stores analysis target text data, and a prompt candidate table that stores generated prompt sentences and associated metadata. Each record in the analysis corpus table may include fields such as a document identifier, a source type indicator (e.g., web document or social communication post), a language identifier, and a vector representation of the text.

The server receives, from the terminal, text information including source conditions. The terminal displays a graphical user interface that allows the user to input network locations (e.g., uniform resource locators), account identifiers for communication services, keywords, time ranges, and optional target reader attributes. The user operates the input device to enter such information, and the terminal transmits a message to the server. The server parses the message, validates the source conditions, and records the conditions in the request table. By structuring the source conditions in a consistent internal format, the server reduces parsing overhead and improves data management efficiency compared to ad hoc input handling.

The server acquires structured document data and posting data from a plurality of information providing devices over the information communication network. For example, the server uses a communication library such as a hypertext transfer protocol client library to issue network requests to remote document servers, and uses an application programming interface client library to retrieve posting data from communication services. The server decodes received hypertext documents and stores the raw hypertext data in the source document table. The server also decodes structured message formats returned by communication services and stores them as posting data records, each including at least a text field, a timestamp, a source identifier, and associated metadata. The server may apply connection pooling and request scheduling to reduce connection overhead and to avoid redundant network transmissions, thereby lowering communication load.

The server converts structured document data into standardized text data using a markup parsing library, such as a generic markup parser. The server removes non-content elements such as script tags and style definitions, and extracts text from main content regions such as article elements, paragraph elements, and heading elements. The server normalizes character encoding, unifies line break formats, and removes or replaces low-information segments such as repeated advertising phrases. The server stores the standardized text data in the normalized text table. This standardized representation allows subsequent natural language processing to operate on a reduced and consistently formatted text set, which decreases memory consumption and processing time compared to processing raw hypertext documents directly.

The server integrates standardized text data, posting data, and any text directly entered by the user to generate analysis target text data. In one embodiment, the server constructs a corpus as a list of document units, where each document unit is associated with a source type and a unique document identifier. The server may aggregate multiple postings into a single document by applying rules such as temporal proximity or shared topic indicators, thereby reducing fragmentation and improving the statistical robustness of later computations. The server stores the analysis target text data in the analysis corpus table, optionally together with precomputed token counts and document length statistics.

The server performs natural language processing on the analysis target text data. In one embodiment, the server uses a natural language processing library such as a general-purpose linguistic analysis toolkit. The server loads one or more language models, for example, models implementing tokenization, part-of-speech tagging, dependency parsing, and named entity recognition. The server performs morphological analysis to decompose text into tokens or morphemes and assigns base forms and syntactic categories. The server performs phrase segmentation by identifying noun phrases, verb phrases, and multi-word expressions using a combination of dependency relations, part-of-speech patterns, and statistical thresholds. The server further performs vectorization by mapping documents and phrases to numerical vectors using algorithms such as term frequency inverse document frequency, subword embeddings, or sentence embedding models.

The server calculates statistical quantities for the analysis target text data based on the vector representations and token distributions. The server computes, for each token and phrase, frequency counts, inverse document frequency values, and combined weighting scores. The server may use a matrix representation of the corpus where each row corresponds to a document and each column corresponds to a term, and the entries are weight values. The server derives importance measures by comparing each term's weight to global statistics, such as the mean and variance across documents. By using these matrix-based operations, the server exploits optimized linear algebra routines, which improves computational efficiency and allows handling of large corpora with reduced latency.

The server extracts important phrases and important sentences based on the statistical quantities and structural features. In one embodiment, the server ranks phrases by their weight scores and filters phrases that satisfy predefined constraints such as minimum length or multi-word requirement. The server identifies compound phrases by detecting sequences of tokens that frequently co-occur and form stable collocations. The server selects important sentences by applying a scoring function that combines sentence-level vector similarity to a topic centroid, coverage of important phrases, and positional information within the document. This scoring function can be implemented as a weighted sum of normalized metrics. The server then generates summary information by selecting top-ranked sentences and ordering them according to their original position and logical coherence.

The server determines topic information based on the important phrases and the summary information. In one embodiment, the server performs hierarchical classification by grouping phrases into clusters using a clustering algorithm, such as agglomerative clustering on phrase vectors, to form topic nodes at multiple levels of granularity. The server may represent the topic structure as a tree where each node corresponds to a topic and stores a list of representative phrases and a centroid vector. The server associates each topic node with potential target reader attributes, such as expert-level or non-expert-level, by matching phrase patterns or using prior configuration. By storing topic information in a structured data model, the server enables efficient retrieval and reuse of topics across requests and reduces redundant computations.

The server generates prompt sentences for input to a generative AI model using template sentence patterns. In one embodiment, the server maintains a template store where each template sentence pattern is associated with a request type, such as explanation request type, summarization request type, comparison request type, or risk analysis request type. Each template includes placeholders for topic labels, context descriptions, and constraints. The server selects one or more templates based on the determined topic information and the occurrence tendency of important phrases. For example, if the analysis target text data includes many occurrences of terms related to risk and regulation, the server may prioritize risk analysis request templates. The server fills the placeholders using topic labels, key phrases, and optional audience descriptors.

The server can generate prompt sentences such as:

“Summarize the latest trends in generative AI based on the collected social communication posts and web articles, and highlight three key technologies that are likely to grow in the next two years.”

“Explain the AI technology trends expected in the near future, with a focus on generative AI models and large language models. Describe both technical developments and business applications in an easy-to-understand way for non-experts.”

“From the analyzed posts about generative AI, identify the main challenges and risks mentioned by experts, and propose possible countermeasures for each.”

“From recent posts about generative AI models, extract the main themes and explain their implications for organizations.”

The server transmits the summary information, important phrases, and generated prompt sentences to the terminal. The terminal displays, on the display device, panels or sections showing summaries, keyword lists, topic labels, and a group of candidate prompt sentences. The user can select a candidate prompt sentence using the input device and optionally edit the sentence to refine the instructions before providing it to a generative AI model. In some embodiments, the terminal can further transmit the selected or edited prompt sentence directly to an external generative AI model via an application programming interface.

In one embodiment, the generative AI model is implemented as a neural network-based text generation model, such as a multi-layer transformer architecture. The model comprises an embedding layer, a plurality of self-attention layers with multi-head attention mechanisms, feed-forward networks, and an output layer that predicts token distributions. The model is trained on a large corpus of text using an objective function such as cross-entropy loss between predicted token probabilities and ground-truth tokens. During training, the model updates weight parameters using an optimization algorithm such as stochastic gradient descent with momentum or adaptive gradient methods, and may use regularization techniques such as dropout and layer normalization. The model thus learns statistical patterns of language that enable it to generate coherent and contextually appropriate text in response to a prompt sentence.

The server does not simply forward user-provided text to the generative AI model; instead, the server implements a specific transformation pipeline that converts heterogeneous raw data into structured topic representations and optimized prompt sentences. This pipeline reduces the need for brute-force human trial-and-error prompt construction and enables the generative model to be used more effectively and efficiently. From a technical perspective, the server improves the functioning of the computer system by optimizing data structures for corpus representation, by performing vector-based scoring with efficient linear algebra operations, by reducing redundant network requests and text parsing, and by precomputing summary and topic features that can be reused across multiple prompt generation requests.

The system achieves technical effects such as increased processing speed, improved accuracy of topic detection, and reduced error rates in prompt construction. For example, the vectorization and hierarchical classification steps enable the server to quickly identify dominant topics without examining every sentence at runtime, which reduces latency when generating new prompt sentences based on updated source conditions. The integration of standardized text data and posting data into a unified corpus structure allows the server to exploit global co-occurrence patterns, thereby improving the precision of important phrase selection compared to simple keyword counting. The use of classified template sentence patterns ensures that prompt sentences are generated in a consistent and structurally appropriate manner, which reduces ambiguity for the generative AI model and can improve generation quality.

In another embodiment, the server uses a secondary neural model to assist in topic determination or template selection. For instance, the server can employ a smaller classifier network that receives as input a document-level embedding and outputs a distribution over request types (explanation, summarization, comparison, risk analysis). This classifier network may use a dense feed-forward architecture with one or more hidden layers, a non-linear activation function such as a rectified linear unit, and a softmax output layer. The classifier is trained on labeled examples where documents are annotated with suitable prompt types. During inference, the classifier guides the selection of template sentence patterns. This approach defines specific features and decision criteria within the AI component, rather than leaving the process as an unbounded “model decision.”

The server may employ non-conventional rules for aggregating and weighting user inputs and analysis outputs. For example, the server may adjust term weights by taking into account the position of occurrences within the document, cross-source consistency, and frequency of associated entities, and may apply non-linear scaling functions. These tailored weighting schemes differ from simple human heuristics and are designed to optimize computational performance in terms of convergence speed and stability of topic classification. As a result, the system reduces sensitivity to noise and outlier phrases, decreasing classification errors and improving robustness.

The terminal contributes to the technical improvement by offloading visualization and interaction tasks from the server, allowing the server to focus on computationally intensive operations. The terminal uses client-side rendering frameworks or native routines to display large sets of summaries and prompt candidates efficiently, and may use incremental rendering or paging to avoid overwhelming the user interface. This division of labor between the server and terminal reduces server-side rendering load and network bandwidth consumption when transmitting analysis results.

Multiple variations of the embodiment are possible. In one variation, the server uses different natural language processing libraries or models for different languages, switching models dynamically based on detected language codes. In another variation, the server uses document embeddings obtained from neural encoders and performs clustering in the embedding space, which can improve topic separation for semantically similar phrases that share few surface tokens. In yet another variation, the server caches intermediate vector representations and summary information for frequently accessed source conditions, thereby further improving processing speed for repeated analyses.

By combining these specific data structures, processing modules, and algorithmic flows, the system implements more than a mere automation of manual reading and writing; the system provides a concrete improvement in how computers acquire, organize, analyze, and transform text data into prompt sentences suitable for generative AI models. The technical configuration of the server and terminal, the detailed processing steps for normalization, vectorization, hierarchical topic classification, and template-based prompt sentence generation, and the defined neural network structures and training procedures together ensure that a person skilled in the art can implement the invention and that the system delivers measurable technical benefits in processing efficiency, accuracy, and reliability.

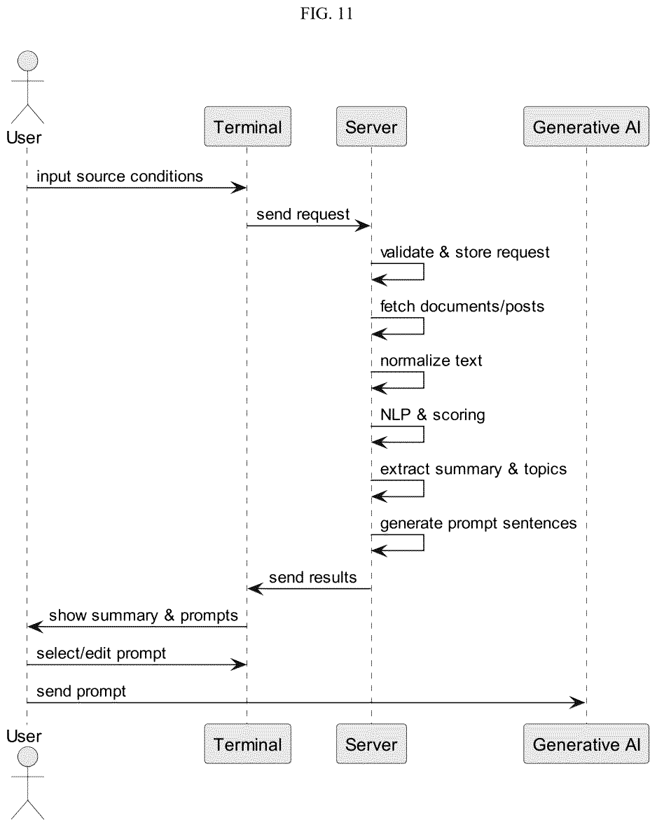

The following describes the processing flow using FIG. 11.

Step 1:

The terminal displays, on a display device, a graphical user interface that includes input fields for source conditions, such as network locations, account identifiers, keywords, and time ranges. The input to this step is a previously loaded web page or application screen provided by the server. The user operates an input device to type one or more network locations, enter identifiers for communication services, specify keywords related to topics of interest, and optionally indicate a target reader attribute. The output of this step is a set of filled input fields on the terminal that represent structured source conditions ready to be transmitted to the server.

Step 2:

The terminal transmits, via a communication interface, the source conditions as a structured request message to the server. The input to this step is the set of filled input fields created in Step 1. The terminal converts the field values into a machine-readable data structure, such as a message including key-value pairs, and sends this message to the server over an information communication network. The output of this step is a received request message at the server that contains text information describing the source conditions.

Step 3:

The server validates the received source conditions and registers them in an internal request table. The input to this step is the request message from the terminal. The server parses the message, checks that each network location has a valid format, verifies limits such as maximum number of sources, and normalizes parameter formats such as date and time ranges. Based on this parsed and validated data, the server writes a new record into a storage device, assigning a unique request identifier and storing the normalized source conditions. The output of this step is a stored request record linking the request identifier to the normalized source conditions.

Step 4:

The server acquires structured document data from external document servers based on the source conditions. The input to this step is the request record containing network locations and related parameters. The server uses a communication library to issue network requests to each specified location, receives hypertext or markup-based documents, and decodes the received data into character strings. The server stores these raw documents in a source document table together with metadata such as source type and retrieval time. The output of this step is a set of stored structured document records associated with the request identifier.

Step 5:

The server acquires posting data from external communication services in accordance with the source conditions. The input to this step is the same request record, including account identifiers, keywords, and optional time ranges. The server uses an application programming interface client to call service endpoints, receives response data in structured formats, and decodes it into posting records that contain text fields, timestamps, and source identifiers. The server stores these posting records in a storage table designated for posting data, indexed by the request identifier. The output of this step is a collection of stored posting records corresponding to social communication content or similar message content.

Step 6:

The server converts structured document data into standardized text data. The input to this step is the set of raw hypertext or markup documents stored in the source document table. The server processes each document using a markup parser, removes non-content elements such as script regions and style regions, and extracts text contained in content structures such as article sections and paragraph elements. The server performs character encoding normalization, removes redundant whitespace, and may replace low-information elements, such as repeated navigation labels, with placeholders or remove them. The output of this step is a set of standardized text fields that are stored in a normalized text table, each linked to its corresponding structured document.

Step 7:

The server integrates standardized text data, posting data, and user-provided text into analysis target text data. The input to this step is the standardized text records from Step 6, the posting records from Step 5, and any free-form text supplied by the user in the original request message. The server groups related postings into aggregated documents, for example by matching account identifiers or keywords and by applying time window rules, and concatenates text segments from standardized documents and postings while inserting document boundary markers. The server stores these integrated text units as analysis documents in an analysis corpus table, assigning each document a unique identifier and linking it to the request identifier. The output of this step is a structured corpus of analysis target text data ready for linguistic processing.

Step 8:

The server performs morphological analysis and tokenization on the analysis target text data. The input to this step is the corpus of integrated text documents from Step 7. The server uses a natural language processing library and a language-specific model to segment the text of each document into tokens or morphemes, assigning attributes such as part-of-speech tags and base forms. The server records token sequences, token positions, and associated attributes in memory or in token tables, and may compute preliminary counts of token occurrences per document. The output of this step is a tokenized representation of each document, including mapping from each document identifier to a sequence of annotated tokens.

Step 9:

The server performs phrase segmentation and extraction of candidate phrases. The input to this step is the tokenized document representation from Step 8. The server identifies phrase boundaries by applying syntactic patterns based on part-of-speech tags, such as sequences representing noun phrases or verb phrases, and by using dependency relations when available. The server groups contiguous tokens into phrases, verifies that the phrases satisfy criteria such as minimum length or multi-word structure, and stores these phrases in a phrase table with references to document identifiers and token positions. The output of this step is a set of candidate phrases for each document.

Step 10:

The server converts documents and phrases into numerical vector representations and calculates statistical quantities. The input to this step is the set of tokenized documents and candidate phrases from Steps 8 and 9. The server builds a vocabulary of terms or phrase units and constructs a matrix where rows correspond to documents and columns correspond to vocabulary items. The server computes weight values, such as term frequency inverse document frequency scores, by applying mathematical formulas to the counts and global occurrence patterns. The server may further project document vectors into a lower-dimensional space using dimensionality reduction methods. The output of this step is a set of vector representations for documents and phrases and a set of statistical quantities, such as weight scores and distribution metrics, stored for later ranking.

Step 11:

The server selects important phrases and important sentences based on the vector representations and statistical quantities. The input to this step is the phrase vectors, document vectors, and associated weight scores from Step 10. The server ranks phrases by their weight values, filters out low-importance or noise phrases based on thresholds or stop-list rules, and designates the remaining phrases as important phrases. For sentences, the server computes a score for each sentence by combining factors such as coverage of important phrases, similarity to a document centroid vector, and sentence position. The server selects the top-scoring sentences from each document and marks them as important sentences. The output of this step is a set of important phrases and important sentences for each document.

Step 12:

The server generates summary information for each document using the important sentences. The input to this step is the set of important sentences and their scores from Step 11. The server arranges the selected sentences in an order that follows the original document sequence or an order that maximizes logical flow, and concatenates them into a shorter text. The server may apply minor adjustments, such as removal of duplicated information and insertion of connective expressions, to improve coherence. The server stores this summary information in a summary table linked to the document identifiers. The output of this step is a summary text for each analysis document.

Step 13:

The server determines topic information and target reader attributes based on the important phrases and summary information. The input to this step is the set of important phrases and the summary texts from Steps 11 and 12. The server clusters phrase vectors to identify groups of semantically related phrases and assigns topic labels to these groups, either by selecting representative phrases or by using predefined mappings. The server organizes these topics into hierarchical structures by merging related clusters at higher levels. In addition, the server infers or assigns target reader attributes according to configuration rules, such as mapping certain domain-specific phrases to an expert audience and more general phrases to a non-expert audience. The output of this step is structured topic information that includes topic labels, hierarchical relationships, and associated target reader attributes.

Step 14:

The server selects template sentence patterns and generates candidate prompt sentences for a generative AI model. The input to this step is the topic information from Step 13 and statistics describing the occurrence tendency of important phrases. The server accesses a template store that contains sentence patterns categorized into types such as explanation request type, summarization request type, comparison request type, and risk analysis request type. The server chooses one or more template types in accordance with the detected topics and the prominence of risk-related or comparison-related phrases. For each selected template, the server fills placeholders with topic labels, key phrases, and audience descriptors to instantiate specific prompt sentences. The output of this step is a group of generated prompt sentences associated with the analysis documents and request identifier.

Step 15:

The server prepares and transmits analysis results and prompt sentences to the terminal. The input to this step is the summary information from Step 12, the important phrases and topic information from Step 11 and Step 13, and the group of candidate prompt sentences from Step 14. The server composes a response data structure that includes, for each document, the summary text, a list of important phrases, topic labels, and associated prompt sentences. The server serializes this structure and sends it to the terminal over the information communication network. The output of this step is a delivered response message that contains the analysis results and prompt sentences.

Step 16:

The terminal displays the analysis results and candidate prompt sentences to the user. The input to this step is the response message received from the server. The terminal decodes the message, extracts summaries, important phrases, topic labels, and candidate prompt sentences, and renders them on the display device as separate sections or panels. The user can see, for example, summary paragraphs, lists of phrases, and prompt sentences such as “Summarize the latest trends in generative AI based on the collected posts and articles” or “Explain the main themes related to generative AI models discussed in the collected sources, and describe their potential impact.” The output of this step is a visual presentation on the terminal that allows the user to inspect and interact with the generated content.

Step 17:

The user reviews the presented summaries, important phrases, and candidate prompt sentences and optionally edits a selected prompt sentence. The input to this step is the displayed information on the terminal. The user selects one of the candidate prompt sentences using the input device, for example by clicking or tapping, and the terminal places the selected sentence into an editable text field. The user then modifies the text to refine the instruction, such as adding constraints on length, level of detail, or focus on a particular subtopic. The output of this step is a finalized prompt sentence as edited and confirmed by the user.

Step 18:

The user provides the finalized prompt sentence to a generative AI model. The input to this step is the edited prompt sentence produced in Step 17. The user may copy the sentence and paste it into a separate interface for a generative AI model or may use a function within the terminal that transmits the sentence directly to an external generative AI model service through a network request. The generative AI model receives the prompt sentence and generates output content in response. The output of this step is the use of the finalized prompt sentence as an input to a generative AI model, enabling the generative AI model to produce content that reflects the analyzed topics and user's intent.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content personalization and online advertising systems typically rely on coarse-grained user profile attributes, such as demographic categories, pre-declared interests, or simple click histories, to determine which advertisement to deliver to a user. In such systems, a computing apparatus generally applies fixed keyword matching or rule-based targeting that does not fully exploit the rich semantic information embedded in user-generated text or in content consumed by the user. As a result, existing systems often fail to capture nuanced user interests and contextual signals, leading to suboptimal ad relevance, reduced user engagement, and inefficient use of computing and network resources.

Furthermore, in many conventional architectures, the generation of advertising content or its guiding instructions is separated from the underlying analysis pipeline, such that a server merely passes static parameters to a content generation component without dynamically shaping the input in response to updated user interest signals. This separation results in an inflexible pipeline, where the generative component cannot adequately reflect the latest user-level text analysis, and thus cannot adaptively refine the style, topic, and specificity of generated ad content. From a computer-technology perspective, this leads to an underutilization of available processing resources and models, increased redundant network traffic due to repeated trial-and-error content generation, and higher latency before a suitable advertisement is found.

In addition, conventional systems rarely integrate a feedback loop in which user interaction with generated advertisements is continuously analyzed and fed back into the interest estimation process and subsequent prompt formation. Without this loop, the server cannot systematically use user behavior data (e.g., views, clicks, dismissals) to recalibrate the internal interest model and to adjust instructions given to a generative AI model. Consequently, the computing system cannot efficiently converge toward more relevant content, and continues to expend computational and network resources on generating and delivering advertisements that may not match the user's evolving interests.

Accordingly, there is a need for a technical solution that improves the functioning of a computer system by: (i) automatically acquiring user-related text content from external sources, (ii) analyzing such content with natural language processing to derive a quantitative interest level, (iii) generating a structured prompt sentence that directly controls a generative AI model in accordance with the computed interest level, and (iv) closing the loop by incorporating user interaction data into the recalculation of interest levels and regeneration of prompt sentences. Such a solution should enable more precise and efficient use of processing, storage, and communication resources, while dynamically tailoring generative AI-based advertising content to user-specific interests in real time or quasi real time.

The specific processing by the specific processing unit 290 of the data processing device 12 in Application Example 1 is realized by the following means.

The present invention provides a server comprising a processor configured to acquire, via a communication interface, content information including text information related to a user from an external information processing apparatus; analyze, using a natural language processing component executed by the processor, the text information included in the acquired content information to detect specific expressions and to calculate an interest level representing a degree of interest of the user on a topic on the basis of an occurrence frequency of the specific expressions; generate, on the basis of the interest level and topic information associated with the specific expressions, a prompt sentence including instruction information for causing a generative AI model to generate personalized advertising information; supply the prompt sentence to the generative AI model and obtain the personalized advertising information generated by the generative AI model; generate advertisement display control information for causing a terminal apparatus to display the personalized advertising information according to the interest level of the user; and further acquire user operation information and response information to the personalized advertising information from the terminal apparatus, analyze the user operation information and the response information, and update the interest level and the prompt sentence on the basis of a result of the analysis. This enables the computer system to automatically and iteratively refine user interest estimation and prompt formation, thereby improving the efficiency and effectiveness of generative AI-based advertisement generation, reducing unnecessary processing and network transmissions, and providing dynamically optimized, interest-driven advertising content with reduced latency and enhanced relevance.

The term “processor” refers to a hardware and/or software processing unit, such as a central processing unit or a combination of processing circuits, configured to execute instructions and perform arithmetic and logical operations required to implement the functions described in the system.

The term “communication function” refers to a hardware and/or software capability that enables an apparatus to send and receive data over a wired or wireless communication network, including but not limited to the use of standardized communication protocols.

The term “information providing apparatus” refers to any computing apparatus or service that stores or distributes content information, such as an online platform, a content server, or a data distribution system that can be accessed via a communication network.

The term “external information processing apparatus” refers to a computing apparatus or system separate from the server of the present invention, which provides content information including text information related to a user via a communication network.

The term “content information” refers to data that includes at least text information and optionally additional information such as metadata, identifiers, timestamps, or media-related attributes, and that is associated with a user or with content consumed by the user.

The term “text information” refers to information expressed in a sequence of characters or symbols representing natural language content, such as sentences, paragraphs, posts, comments, titles, or article bodies.

The term “user-related text information” refers to text information that is posted, generated, interacted with, or otherwise associated with a specific user, and that can be used to infer the user's interests or preferences.

The term “language processing apparatus” refers to a software and/or hardware component configured to perform natural language processing on text information, including operations such as tokenization, part-of-speech tagging, phrase detection, and semantic analysis.

The term “natural language processing” refers to a set of computational techniques for analyzing and processing human language text, including but not limited to tokenization, syntactic parsing, named entity recognition, keyword detection, and semantic interpretation.

The term “specific expressions” refers to words, phrases, or linguistic patterns within text information that are predetermined or learned to be indicative of certain topics, concepts, or user interests.

The term “occurrence frequency” refers to a quantitative value indicating how many times a specific expression appears within a given set of text information, optionally normalized by text size or document count.

The term “topic” refers to a conceptual category or subject matter, such as a field of interest or domain, that can be associated with specific expressions and used for determining a user's interest.

The term “interest level” refers to a numerical or categorical indicator representing the degree or strength of a user's interest in a particular topic, computed on the basis of the occurrence frequency of specific expressions and optionally other signals.

The term “topic information” refers to data indicating one or more topics associated with specific expressions, including identifiers, labels, or descriptive metadata that describe the subject matter represented by the expressions.

The term “prompt sentence” refers to a natural language expression that includes instructions or conditions used to control or guide the behavior of a generative AI model when generating output information such as advertising information.

The term “prompt sentence generation instruction information” refers to information included within a prompt sentence that specifies how a generative AI model should generate content, such as constraints, personalization conditions, or content types.

The term “generative AI model” refers to an artificial intelligence model capable of generating content, such as text, images, or other media, in response to input data including prompt sentences.

The term “generative information generation apparatus” refers to a computing component that includes or accesses a generative AI model and that generates information content based on input instructions.

The term “advertising information” refers to content data intended to promote products, services, brands, or other items, and may include text, images, links, or other media structured for display to a user.

The term “personalized advertising information” refers to advertising information whose content, style, or structure is adapted or selected according to a specific user's interest level, behavior, or profile.

The term “advertisement display control information” refers to control data generated by the processor that specifies how, when, or where advertising information is to be displayed on a terminal apparatus, including layout, timing, and selection parameters.

The term “terminal apparatus” refers to an end-user device, such as a personal computer, smartphone, tablet, or other client device, that presents information to the user and is capable of communicating with the server.

The term “display apparatus” refers to a hardware output device, such as a screen or display panel, associated with a terminal apparatus and configured to visually present information including advertising information to a user.

The term “statistical estimation technique” refers to a computational method that uses statistical models or formulas, such as frequency analysis, normalization, or probabilistic estimation, to evaluate numerical values from observed data.

The term “normalization processing” refers to a data transformation operation that adjusts values, such as occurrence frequencies, into a common scale or range to allow meaningful comparison or aggregation.

The term “weighting processing” refers to an operation in which different values, such as occurrence frequencies of specific expressions, are multiplied by predefined or learned weights to reflect their relative importance.

The term “numerical index” refers to a numerical value, such as a scalar or score, that quantitatively represents a property such as the user's interest level in a topic.

The term “user profile information” refers to data representing characteristics of a user, including numerical indices such as interest levels, and any associated topics or metadata stored and updated over time.

The term “storage apparatus” refers to any hardware or combination of hardware and software configured to store data, such as a memory device, a storage medium, or a database system.

The term “expression content” refers to textual elements, such as words or phrases, that are selected or generated for inclusion in a prompt sentence or other output on the basis of user profile information.

The term “user operation information” refers to data indicating operations performed by a user on a terminal apparatus, including actions such as selections, clicks, taps, scrolling, or other interface interactions.

The term “response information to the advertising information” refers to data indicating how a user reacts to displayed advertising information, including events such as views, clicks, dismissals, conversions, or dwell time.

The term “recalculation of the interest level” refers to a process of computing an updated interest level by incorporating additional information, such as user operation information or response information, into the interest estimation algorithm.

The term “real time or quasi real time” refers to a mode of system operation in which processing and updates, such as the regeneration of prompt sentences and advertising information, are performed with sufficiently low delay to respond promptly to changes in user behavior.

In one embodiment, a server executes a set of computer programs on a hardware platform including at least one central processing unit, a main memory, a non-volatile storage device, and a network interface. The server operates under an operating system such as a general-purpose server operating system and runs an application stack that includes a web server component, an application logic component, and a data management component. The server is connected via a communication network to at least one external information processing apparatus that provides content information, and to at least one terminal operated by a user.

The server uses software libraries for network communication, such as an HTTP client library, to acquire content information from the external information processing apparatus. The server obtains content information in a structured data format, for example as records having fields such as a content identifier, a user identifier, a timestamp, a text field, and optional metadata fields. The server stores the received records in a relational database management system or in a key-value data store, using tables or collections that index the records by user identifier and by topic identifier. By storing the data in indexed structures, the server reduces access time and improves throughput for subsequent analysis operations.

The server analyzes text information contained in the content information using a natural language processing library installed in the execution environment. In one embodiment, the server uses a natural language processing library such as a general-purpose natural language processing toolkit that provides a pipeline including tokenization, sentence segmentation, part-of-speech tagging, dependency parsing, and named entity recognition. The server loads a pre-trained language model associated with the toolkit into memory. The server passes each text field from the stored records into this pipeline and receives, as output, a tokenized representation, grammatical annotations, and recognized entities. The server constructs a feature vector for each piece of text by counting occurrences of predetermined specific expressions and by aggregating syntactic and semantic features such as parts of speech, dependency labels, and entity types.

The server defines specific expressions as entries in a topic-expression dictionary stored in the database. Each dictionary entry includes a term string, a topic identifier, a base weight, and optional context conditions such as required neighboring tokens or part-of-speech patterns. The server matches the tokens produced by the natural language processing pipeline against the topic-expression dictionary. When the server finds a match, the server increments a count associated with the corresponding topic identifier and optionally accumulates weighted counts depending on the base weight and contextual features. The server maintains, in memory or in a dedicated database table, a data structure that stores, for each user and each topic, the total occurrence count, the total token count, and the total document count.

The server computes an interest level for each topic by applying a numerical algorithm to the accumulated counts. In one embodiment, the server computes a normalized frequency by dividing the weighted occurrence count by the total token count or by the total document count. The server multiplies the normalized frequency by a topic-specific scaling factor to obtain a preliminary score. The server then applies a non-linear transformation, such as a logistic function or a piecewise linear mapping, to confine the score to a predetermined range, for example between 0 and 1. The server stores the resulting interest level for each user-topic pair as a numerical index in a user profile data structure. The user profile data structure may be implemented as a row in a relational table or as a document in a document-oriented store, containing fields representing topic identifiers, interest levels, and update timestamps.

The server constructs a prompt sentence for a generative AI model by combining the computed interest level with topic information associated with the specific expressions. The server generates the prompt sentence as a natural language sequence that includes explicit instructions, constraints, and personalization information. The server uses a prompt template management module that stores several template patterns. Each template pattern defines placeholders for topic labels, interest level values, and description of desired advertising content. The server selects a template pattern based on the highest-interest topic and fills the placeholders with the corresponding topic label and a description derived from the topic-expression dictionary.

The server may generate a prompt sentence such as:

“You are a generative AI model that creates personalized advertisements. The user has a high interest level in travel, hotels, and flights. Generate a concise advertising prompt sentence that instructs the creation of an advertisement recommending discounted hotels and convenient flight options for the user's next international trip.”

The server may generate another prompt sentence such as:

“The user frequently posts about travel destinations, beach resorts, and vacation planning, and the computed travel interest level is 0.87 on a scale from 0 to 1. Generate a single prompt sentence that will guide a generative AI model to produce an advertisement highlighting exclusive hotel deals and tailored travel packages.”

The server may further generate a more generic prompt sentence template such as:

“When the user's primary interest topic is travel, generate an advertising prompt sentence that encourages the user to discover recommended hotels and travel offers suitable for their upcoming trip.”

The server supplies the constructed prompt sentence to a generative AI model hosted on a generative information generation apparatus. In one embodiment, the generative AI model is implemented as a transformer-based neural network comprising multiple self-attention layers and feedforward layers. The server transmits the prompt sentence to the generative AI model via a network interface using a request-response protocol. The server specifies model parameters such as maximum output length, sampling temperature, and decoding strategy. The generative AI model receives the prompt sentence as tokenized input, computes attention weights across layers to capture contextual relationships, and generates output tokens representing advertising information in the form of text content.

The server receives the output tokens from the generative AI model, decodes the tokens into a text sequence, and interprets the text sequence as advertising information. The server may parse the advertising information into components such as a headline, a body text, and a call-to-action phrase, using predetermined markers or heuristic segmentation. The server then constructs an advertisement object that includes these textual components, a reference to a media resource such as an image or a video, and a landing resource identifier such as a uniform resource locator. The server stores the advertisement object in an advertisement repository and associates it with the corresponding user profile and interest level.

The server generates advertisement display control information for a terminal. The server selects an advertisement object for a user based on the user's current interest profile and on scheduling constraints. The server packages the advertisement object and related control parameters, such as display position, display duration, priority level, and refresh policy, into a control message. The server transmits the control message to the terminal over the communication network using a secure transport protocol.

The terminal operates as a client device such as a smartphone, a tablet, or a personal computer. The terminal includes a processor, a memory, a display, and input interfaces. The terminal executes a client application or a web browser that is configured to communicate with the server. The terminal receives the advertisement display control information from the server and parses the control message to extract the advertisement object and presentation parameters. The terminal loads the associated media resources and renders the advertisement on the display in accordance with the control parameters. The terminal displays, for example, a travel-related advertisement including a headline such as “Save on Your Next Hotel Stay,” a body text such as “Discover top-rated hotels with up to 30% off for your next vacation,” and a call-to-action such as “Book now.”

The user interacts with the advertisement via the terminal. The user may click, tap, scroll past, or dismiss the advertisement. The terminal records user operation information such as click events, view durations, and dismiss actions, and the terminal transmits this information back to the server in the form of event logs. The terminal may also transmit contextual information such as the time of interaction, the location within an application where the advertisement was displayed, and the identifier of the advertisement object.

The server receives the user operation information and response information related to the advertising information. The server writes these records to an analytics data store that associates events with user identifiers and advertisement identifiers. The server analyzes this data by computing statistics such as click-through rates and dwell times for each topic and for each advertisement variant. The server updates the interest level by incorporating these behavioral statistics. For example, the server may increase the interest level for topics associated with advertisements that receive high engagement and decrease the interest level for topics associated with advertisements that are frequently dismissed. The server recalculates the interest level using a weighted combination of the text-derived interest score and the behavior-derived engagement score. By doing so, the server adjusts the numerical index to better reflect the user's current preferences.

The server regenerates a prompt sentence based on the updated interest level. The server selects a new template or modifies an existing template to reflect the recent behavior. The server may, for example, adjust the level of detail in the prompt sentence or shift emphasis among subtopics within a broader topic category. The server again supplies the updated prompt sentence to the generative AI model, receives updated advertising information, and sends updated advertisement display control information to the terminal in real time or quasi real time. This feedback loop allows the system to continuously refine the match between user interests and generated advertising content.

The server, by executing this pipeline, improves computer technology in several ways. By using a structured topic-expression dictionary and a normalized interest-level computation, the server reduces the dimensionality of text features and focuses computation on topic-relevant signals, which leads to improved processing speed and reduced memory usage compared to naive keyword-based counting or full-text similarity measures. By organizing user profiles as numerical indices tied to topics, the server can quickly retrieve and update interest levels using indexed database queries, thereby decreasing latency in personalization and enabling near real-time adaptation.

The server also improves the efficiency of generative model usage. Instead of repeatedly invoking a generative AI model with vague, generic prompts, the server constructs prompt sentences that encapsulate precise, numerically derived interest information and topic descriptors. This targeted prompting reduces the number of iterations needed to obtain suitable outputs and decreases network bandwidth and computational load associated with generative model calls. As a result, the system minimizes redundant generation and allows more users to be served within the capacity of a given hardware configuration.

The server incorporates a non-conventional processing sequence in which natural language processing, statistical interest estimation, prompt sentence construction, generative model interaction, and behavioral feedback analysis are tightly integrated. This sequence differs from simple human-like manual generation or static rules because the server applies quantitatively defined thresholds, weighted feature aggregations, and dynamic updating algorithms that would be impractical to perform manually. The server applies algorithmic rules that combine text-derived signals and behavior-derived signals in a way that enhances prediction accuracy for user interest and thereby improves targeting precision beyond human heuristics.

The server may employ different neural network architectures for the generative AI model in alternative embodiments. In one embodiment, the generative AI model is a transformer network with multiple encoder-decoder layers, each layer containing multi-head self-attention sublayers and position-wise feedforward sublayers. In another embodiment, the generative AI model may be a decoder-only transformer architecture that processes the prompt sentence and generates output tokens using causal self-attention. In each case, the model is trained using supervised or semi-supervised learning on large corpora of text. During training, the model minimizes a loss function such as cross-entropy between predicted tokens and ground-truth tokens, and the model updates internal weights via gradient descent or a variant such as Adam optimization. The server accesses such a pre-trained model and uses fine-tuning or parameter-efficient adaptation techniques to better align generated outputs with advertising goals, such as rewarding outputs that include certain structures or topics.

The server may apply additional processing to the prompt sentence before sending it to the generative AI model. For example, the server may encode numerical interest levels in natural language form (e.g., “very high interest in travel”) or as explicit scalar values (e.g., “interest score: 0.87”) to give the model clear signals about the desired degree of emphasis. The server may also introduce constraints in the prompt sentence, such as “do not mention unrelated topics,” or “limit the output to two sentences,” which help the model generate concise and focused advertising information. By structuring the prompt sentence in this manner, the server effectively controls the internal behavior of the generative AI model in a predictable way.

The server can be configured to handle multiple users and multiple topics concurrently. The server distributes processing across threads or processes and may deploy separate worker modules for text analysis, interest computation, prompt generation, and advertisement rendering. The server may use load-balancing techniques to allocate workloads based on current system utilization, thereby improving responsiveness under heavy traffic. The server may cache frequently used prompt templates and intermediate analysis results so that the server does not recompute interest levels and templates from scratch for every request, thus improving overall computational efficiency.

The terminal may support different presentation formats in other embodiments. The terminal may display advertising information as an overlay, as part of a scrolling feed, or as an interstitial view, depending on the advertisement display control information. The terminal may adapt font size, color scheme, and layout according to device characteristics such as screen size and resolution. The terminal may also prefetch upcoming advertisement resources as instructed by the server so that transitions appear seamless to the user, which further improves user experience and reduces perceived latency.

The user may be provided with an interface on the terminal to directly adjust preferences or to opt in or out of certain topic categories. The terminal transmits these explicit preferences to the server, and the server stores them in the user profile data structure. The server may treat such explicit preferences as additional features in the interest-level calculation, for example by setting minimum or maximum bounds on interest levels or by zeroing out interest levels for disallowed topics. This integration of explicit preferences with computed interest signals gives the server a more accurate representation of user intent and allows more precise control over generated advertising information.

Through these configurations, the server, the terminal, and the user cooperate in a system in which a generative AI model is controlled via precisely crafted prompt sentences derived from structured interest-level computations. The server performs specific data processing and numerical operations that enhance computational efficiency, accuracy of personalization, and the technical performance of the overall system, rather than merely automating a human advertising task.

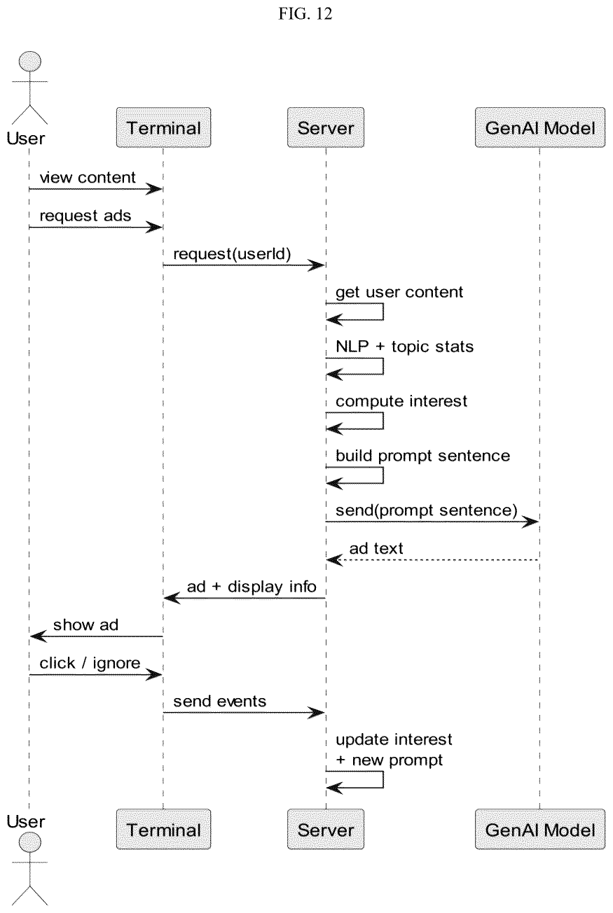

The following describes the processing flow using FIG. 12.

Step 1:

The server acquires user-related content information from external information processing apparatuses.

The server receives, as input, a user identifier, authentication tokens, and optional topic filter parameters from the terminal. Based on this input, the server constructs network requests (for example, HTTP GET requests with query parameters) to external content providers and retrieves content records that include fields such as content ID, user ID, timestamp, and text information. The server parses the responses and writes the content records into a storage structure, such as a relational database table indexed by user ID and timestamp. As output, the server produces a set of stored content records associated with the target user.

Step 2:

The server preprocesses the text information contained in the acquired content records.

The server reads, as input, the raw text fields (for example, titles, bodies, captions) from the stored content records. The server performs data processing operations including character encoding normalization, conversion to a uniform case, removal of markup (such as HTML tags), URLs, and extraneous symbols, and optional removal of predefined stop words. The server applies string transformation functions and regular expression matching to generate cleaned text. As output, the server stores normalized text strings in association with the original records, producing updated content records that contain both raw text and normalized text.

Step 3:

The server executes natural language processing on the normalized text to produce linguistic annotations.

The server receives, as input, the normalized text strings from the updated content records. The server passes each text string into a natural language processing pipeline provided by a language processing library, which performs tokenization, part-of-speech tagging, dependency parsing, and named entity recognition. The server obtains, as output, annotated text objects that include token lists, token positions, POS tags, dependency relations, and entity labels. The server stores or caches these annotated objects in memory or in a dedicated annotation store for later use.

Step 4:

The server detects specific expressions and aggregates occurrence frequencies per topic.

The server reads, as input, the annotated text objects and a topic-expression dictionary that maps specific expressions to topic identifiers and base weights. The server iterates over tokens and n-grams in each annotated object, matches them against dictionary entries, and checks contextual constraints such as surrounding tokens or POS patterns. For each successful match, the server increments a topic-specific occurrence count and accumulates weighted counts using the base weight and any context-based adjustments. As output, the server generates, for each user and for each topic, a set of counters including total occurrence count, total weighted count, total token count, and total document count, and stores these counters in a per-user topic statistics structure.

Step 5:

The server computes an interest level for each topic based on the aggregated statistics.

The server receives, as input, the per-user topic statistics, which include weighted occurrence counts and normalization factors. The server executes a numerical computation in which the server divides the weighted occurrence count by the total token count or document count to obtain a normalized frequency, multiplies the normalized frequency by a topic-specific scaling factor, and applies a non-linear mapping such as a logistic function to confine the result to a defined range. The server may also combine text-based scores with historical engagement scores stored from prior interactions. As output, the server produces an interest level value for each topic and records these values as numerical indices in a user profile data structure.

Step 6:

The server selects a primary topic and prepares structured input for prompt sentence generation.

The server uses, as input, the set of interest levels stored in the user profile and associated topic metadata such as topic labels and descriptions. The server ranks the topics according to interest level and selects one or more primary topics exceeding a threshold. The server retrieves representative expressions or sample phrases from the topic-expression dictionary to characterize the selected topics. The server aggregates this information into a structured context representation, which includes topic names, interest scores, and typical expressions. As output, the server generates an internal context object that will be used to construct a prompt sentence for a generative AI model.

Step 7:

The server constructs a prompt sentence for the generative ai model based on the context object.

The server takes, as input, the context object containing primary topics, interest levels, and representative expressions, and a set of prompt templates stored in a template repository. The server selects an appropriate template according to the highest-interest topic and desired advertising type (for example, recommendation-type ad). The server fills template placeholders with topic names, interest scores, and descriptive phrases, and may add constraints such as length limits or exclusion of irrelevant topics. As output, the server generates a natural language prompt sentence, such as: “You are a generative AI model that creates personalized advertisements. The user has a high interest level in travel, hotels, and flights. Generate a concise advertising prompt sentence that instructs the creation of an advertisement recommending discounted hotels and convenient flight options for the user's next international trip.”

Step 8:

The server sends the prompt sentence to the generative AI model and obtains generated advertising information.

The server receives, as input, the constructed prompt sentence and the configuration parameters for the generative AI model, such as model identifier, maximum token count, and sampling parameters. The server transmits the prompt sentence to the generative information generation apparatus via a network interface using a request protocol, and the generative AI model processes the prompt sentence through its neural network layers to produce output tokens. The server then receives the generated output tokens, decodes them into a text sequence, and treats the text sequence as advertising information including at least a headline and body content. As output, the server stores the generated advertising text in an advertisement object associated with the user and topic.

Step 9:

The server structures the advertising information and generates advertisement display control information.

The server uses, as input, the generated advertising text and system-level display rules stored in a configuration repository. The server parses the advertising text into logical segments such as headline, body, and call-to-action by applying pattern recognition rules or delimiter detection. The server associates these segments with optional media resources and a destination resource identifier. The server composes an advertisement object including content fields and display parameters such as priority, placement, and duration. As output, the server creates advertisement display control information that encapsulates the advertisement object and presentation directives for the terminal.

Step 10:

The server delivers the advertisement display control information to the terminal.

The server receives, as input, a request from the terminal that contains a user identifier or session token indicating the user context. The server selects an appropriate advertisement object for the user from the advertisement repository, packages the advertisement and control parameters into a response message, and sends the message to the terminal over the communication network. As output, the server provides the terminal with all data required to render the personalized advertisement corresponding to the computed interest level.

Step 11:

The terminal renders the personalized advertisement on the display.

The terminal takes, as input, the advertisement display control information from the server. The terminal parses the received message to extract the advertisement object, including headline, body text, call-to-action, media resource identifiers, and placement directives. The terminal loads associated media resources, allocates a display region according to the placement directives, and composes a visual representation by drawing text and media onto the display. As output, the terminal presents a personalized advertisement to the user, such as a travel-related promotion with an appropriate message and imagery.

Step 12:

The user interacts with the displayed advertisement via the terminal.

The user receives, as input, the visual advertisement rendered on the display and may perform operations such as tapping, clicking, or dismissing the advertisement, or ignoring it. The user's interactions generate user operation information (for example, click events, view durations, scroll actions) within the terminal's user interface. As output, the user causes the terminal to record these events and prepare response data reflecting how the user engaged with the advertisement.

Step 13:

The terminal transmits user operation information and response information to the server.

The terminal uses, as input, the locally recorded user operation information, including event type, timestamp, advertisement identifier, and user identifier or session token. The terminal packages this information into one or more event messages and sends the messages to the server over the communication network using a reporting API. As output, the terminal provides the server with structured behavioral data that reflects user responses to the advertising information.

Step 14:

The server updates interest levels and regenerates prompt sentences based on user behavior.

The server receives, as input, the event messages containing user operation information and response information associated with specific advertisements and topics. The server aggregates these events into engagement metrics such as click-through rate and dwell time per topic and per advertisement. The server combines these engagement metrics with the existing text-based interest levels using a weighted formula, recalculates updated interest levels, and writes the new numerical indices into the user profile data structure. The server then re-executes the prompt construction process using the updated interest levels, generating a new prompt sentence that reflects the latest user behavior. As output, the server produces updated prompt sentences and, after invoking the generative AI model again, updated advertising information that can be delivered to the terminal in real time or quasi real time.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional text analysis systems that detect specific expressions (for example, laughter-related slang or emphatic markers) in user-generated content typically perform simple keyword counting or rule-based tagging. Such systems often operate as application-level features layered on top of generic text processing pipelines and do not adapt their internal processing based on nuanced user sentiment or community-wide recognition of the expressions. As a result, these systems frequently produce coarse or misleading measures of user reaction, such as “funny” or “not funny,” without capturing the intensity or quality of the reaction in a technically robust manner.

In addition, many existing systems generate static visual feedback (such as fixed icons or generic charts) that is not tightly integrated with the underlying text analysis logic. The generation of visual feedback is often hard-coded in the client application or the front-end layer and is not dynamically parameterized by the detailed statistical properties of the detected expressions or by machine-learned emotion analysis. This separation leads to duplicated logic across components, inconsistent behavior between different deployment environments, and an inability to scale or update the feedback generation pipeline efficiently. Further, conventional architectures rarely leverage a generative AI model as a programmable rendering back-end controlled by machine-generated prompt sentences that encode both numerical evaluation results and desired visual element parameters. Instead, generative AI is often used in an ad hoc manner, with manually authored prompts that are not systematically linked to the text analysis process. This limits reproducibility, makes it difficult to guarantee consistent behavior for similar inputs, and prevents the system from exploiting the full expressive power of generative models as part of a controlled, server-side computation pipeline.

Moreover, known systems do not sufficiently incorporate “general recognition” of specific expressions such as how a given community typically interprets a particular expression into a unified computation that combines statistical occurrence counts, reference information stored in a data repository, and machine-learned emotion analysis. Without an integrated weighting and normalization framework on the server side, the computed “funniness” or similar reaction metrics tend to be brittle, domain-specific, and difficult to calibrate or reuse across applications.

There is therefore a need for an improved computer-implemented system and server-side processing architecture that: (i) performs structured language analysis and expression detection using tokenization and regular-expression-based counting; (ii) combines occurrence statistics with stored general-recognition reference data and emotion analysis based on machine learning; and (iii) automatically generates machine-readable prompt sentences that encode quantitative evaluation results and dynamic visual parameters for a generative AI model. Such a system should improve the technical functioning of the server by unifying text analysis, evaluation computation, and visual feedback generation into a coherent processing pipeline, thereby reducing redundancy, improving consistency, and enabling real-time, personalized visual feedback with reduced client-side complexity.

The specific processing by the specific processing unit 290 of the data processing device 12 in Example 2 is realized by the following means.

The present invention provides a server comprising a processor configured to receive text information as text data from a user terminal via a communication network, perform language analysis including tokenization on the text information by using a character string processing program and a natural language processing program to detect a predetermined group of expressions included in the text information, calculate an occurrence number for each expression of the predetermined group of expressions by using regular expression processing and character string arithmetic processing to generate occurrence number data, calculate an evaluation value for the occurrence number data by performing statistical processing using a coefficient and a threshold defined for each expression and determine a funniness level classified into a predetermined category based on the evaluation value, analyze an emotional expression included in the text information by using an emotion analysis program based on a machine learning algorithm to generate emotion analysis result data, generate evaluation information including numerical information and category information reflecting the occurrence number of the predetermined group of expressions and general recognition thereof based on the funniness level and the emotion analysis result data, construct a prompt sentence including an explanatory sentence describing the evaluation information and generation conditions of visual feedback, generate prompt sentence data for instructing a generative information processing model to generate the visual feedback based on the prompt sentence data, and transmit, as output data, the funniness level, the emotion analysis result data, and the visual feedback generated by the generative information processing model to the user terminal. This enables a technically improved server-side processing pipeline in which expression detection, statistical evaluation, emotion analysis, and visual feedback generation are integrated; wherein the server automatically encodes analysis results and visual element parameters into machine-generated prompt sentences for the generative AI model, thereby reducing client-side processing burden, improving consistency and reproducibility of feedback, and providing real-time, dynamically parameterized visual outputs that more accurately reflect user sentiment and community recognition of specific expressions.

The term “text information” refers to character-based content including sentences, words, symbols, and punctuation that is input by a user and processed as digital data by a computer system.

The term “text data” refers to a digital representation of text information encoded in a machine-readable format suitable for storage, transmission, and processing by a processor.

The term “user terminal” refers to an electronic apparatus, such as a mobile device, a personal computer, or a tablet device, that is operated by a user to input, transmit, receive, and display information via a communication network.

The term “communication network” refers to a wired or wireless data transmission infrastructure, including public networks and private networks, that enables data exchange between the user terminal and the server.

The term “processor” refers to one or more hardware-based processing units, such as central processing units or graphics processing units, configured to execute instructions of software programs to perform computational operations.

The term “character string processing program” refers to software configured to perform operations on sequences of characters, including searching, matching, splitting, concatenating, and transforming character strings.

The term “natural language processing program” refers to software configured to analyze, interpret, and process human language expressions using algorithms for tokenization, parsing, tagging, or semantic analysis.

The term “tokenization” refers to a process of segmenting text information into smaller units, such as words, symbols, or subword units, that can be individually analyzed by a processor.

The term “language analysis” refers to processing operations applied to text information, including tokenization, syntactic analysis, semantic analysis, or other linguistic processing, to extract structural or semantic features.

The term “predetermined group of expressions” refers to a set of specific words, phrases, symbols, or patterns that are defined in advance as targets for detection and analysis in the text information.

The term “regular expression processing” refers to pattern-matching operations that use formal pattern descriptions to search, identify, and extract substrings that satisfy specified conditions within text data.

The term “character string arithmetic processing” refers to computational operations on character strings, including counting, indexing, and aggregating occurrences of specified substrings or characters.

The term “occurrence number” refers to a count value representing how many times a particular expression of the predetermined group of expressions appears within the text information.

The term “occurrence number data” refers to structured data representing the occurrence number for one or more expressions, typically as numerical values associated with corresponding expressions.

The term “statistical processing” refers to computational operations that apply statistical methods, such as weighting, normalization, thresholding, or estimation, to numerical data derived from text analysis.

The term “coefficient” refers to a numerical parameter defined for an expression and used to weight the contribution of the occurrence number of that expression in a statistical computation.

The term “threshold” refers to a reference value used to determine category boundaries or decision points when evaluating numerical data, such as occurrence numbers or computed scores.

The term “evaluation value” refers to a computed numerical measure that quantifies a property of the text information, such as a degree of funniness, based on statistical processing of occurrence number data and associated parameters.

The term “funniness level” refers to a qualitative or quantitative indication of how humorous the text information is assessed to be, derived from the evaluation value and classified into one or more predefined categories.

The term “predetermined category” refers to a defined class, label, or level, such as low, medium, or high, used to categorize the funniness level or other evaluation outcomes based on rules or thresholds.

The term “emotional expression” refers to a portion of the text information that conveys or implies a user's emotional state, such as amusement, joy, anger, sadness, or surprise.

The term “emotion analysis program” refers to software configured to infer or classify emotional states from text information using computational techniques, including machine learning algorithms.

The term “machine learning algorithm” refers to a computational method that adjusts internal parameters based on training data to perform tasks such as classification, regression, or prediction on new input data.

The term “emotion analysis result data” refers to data representing the outcome of emotion analysis, including one or more emotion categories, intensities, or scores associated with the text information.

The term “evaluation information” refers to data that combines numerical information and category information derived from the evaluation value, the funniness level, the occurrence number data, and emotion analysis result data.

The term “numerical information” refers to one or more numerical values, such as scores, counts, weights, or probabilities, that quantitatively describe properties of the analyzed text information.

The term “category information” refers to one or more labels or classes assigned to the text information, such as funniness categories or emotion categories, based on evaluation rules or thresholds.

The term “general recognition” refers to commonly accepted or statistically inferred interpretations, associations, or connotations of specific expressions within a user community or population, as represented in reference data.

The term “information storage unit” refers to a storage apparatus, including memory devices or storage devices, configured to store data such as general recognition reference information and evaluation criteria.

The term “evaluation reference information” refers to stored data defining criteria, mappings, or parameters that relate expressions or occurrence patterns to perceived funniness or other evaluative attributes.

The term “prompt sentence” refers to a text sequence that encodes instructions, conditions, and contextual information to control operation of a generative information processing model.

The term “prompt sentence data” refers to a machine-readable representation of one or more prompt sentences used to instruct a generative information processing model to generate output content.

The term “generative information processing model” refers to a computational model, such as a generative artificial intelligence model, that generates new data, including text, images, or other media, based on input prompt sentence data.

The term “visual feedback” refers to image data, graphical elements, or visual representations generated in response to analysis of text information, including charts, icons, animations, or composite images.

The term “visual element” refers to a component of visual feedback, such as a color region, shape, symbol, graphical object, or animation, that can be parameterized and manipulated by the processor.

The term “parameter of a visual element” refers to a control value, such as color tone, shape type, size, layout position, or animation effect, that determines the appearance or behavior of a visual element.

The term “generation condition of visual feedback” refers to one or more parameters, constraints, or rules that specify how a generative information processing model should compose or render visual feedback.

The term “output data” refers to data transmitted from the server to the user terminal, including evaluation information, emotion analysis result data, funniness level indicators, and visual feedback data.

The term “real time” refers to processing and output performed with latency sufficiently low that a user perceives responses as substantially immediate during interactive use of the system.

In one embodiment, a server, a terminal, and a user cooperate to implement the claimed system.

The server includes at least one hardware processor, a main memory, a non-volatile storage device, and a network interface. The server executes an operating system such as a general-purpose server operating system and middleware such as a web server and an application server. The server executes application software implemented, for example, in a programming language that provides libraries for text processing, such as Python. The server uses software components corresponding to a character string processing program, a natural language processing program, an emotion analysis program based on a machine learning algorithm, and an interface to a generative AI model. The server further uses a relational database management system as an information storage unit for storing general recognition data, evaluation reference information, and logs.

The terminal is a user-operated computing device such as a smartphone, a tablet, or a personal computer. The terminal executes an operating system such as a mobile operating system or a desktop operating system and provides a graphical user interface through a web browser or a native application. The terminal provides an input field that enables the user to input text information. The terminal includes a communication module that transmits data to and receives data from the server via a communication network such as the Internet using a communication protocol such as HTTP or HTTPS.

The user operates the terminal to input text information, for example, an informal comment or reaction to content. The user inputs, as one specific example, the text: “This movie is so funny, warau w w w”. The terminal sends this text information to the server as text data. The server receives this text data and stores it temporarily in the main memory in a data structure such as a string buffer or a request object containing fields for the raw text, a user identifier, and a timestamp.

The server uses the character string processing program and the natural language processing program to perform language analysis of the received text information. The server uses a natural language processing library such as a Japanese-language model implemented in a general NLP toolkit to perform tokenization, part-of-speech tagging, and basic syntactic analysis. The server converts the raw text into a sequence of tokens, each represented by a data structure including a surface form, a normalized form, and optional features such as a part-of-speech tag.

The server uses a regular expression engine, such as the pattern-matching functionality provided by the language runtime, as part of the character string processing program. The server defines a predetermined group of expressions including specific symbols and words that tend to indicate amusement or laughter in user-generated texts. In one example, the predetermined group of expressions includes the character “warru” and sequences of the character “w”. The server defines regular expression patterns such as “warau” and “w+” and applies these patterns to the token sequence or to the raw text stored in memory. The server generates occurrence number data by counting the number of matches for each pattern. The server uses data structures such as hash maps or dictionaries that map each expression identifier to an integer occurrence count and optionally to a list of positions within the text. The server performs statistical processing on the occurrence number data. The server stores, in the information storage unit, coefficients and thresholds for each expression. For example, the server assigns a higher coefficient to “warau” than to a single “w” because general recognition data indicates that “warau” expresses stronger laughter. The server retrieves these coefficients and thresholds and computes an evaluation value using an arithmetic formula that combines the weighted occurrence counts. The server also applies normalization functions that map raw scores into a bounded range. The server compares the resulting evaluation value with predefined thresholds to determine a funniness level, such as “LOW”, “MEDIUM”, or “HIGH”. The server stores the funniness level and intermediate calculation results in memory as structured records.

The server stores general recognition information for each member of the predetermined group of expressions in the information storage unit. The server stores, for example, for each expression, a probability distribution representing how crowdsourced annotators or community data associate the expression with various reaction intensities. The server uses this stored recognition information to adjust coefficients and thresholds dynamically. The server can update the stored recognition information by retraining models or by aggregating new usage statistics, which improves calibration over time.

The server executes the emotion analysis program to analyze emotional expressions in the text. In one embodiment, the server uses a neural network model configured as a multi-layer architecture including an embedding layer, a sequence encoding layer, and a classification layer. The server maps each token in the text to a numeric embedding vector using a pre-trained word embedding matrix stored in memory. The server then applies a sequence model, such as a bidirectional recurrent neural network or a transformer encoder, to compute a contextual representation of the entire text. The server passes the contextual representation through one or more fully connected layers with nonlinear activation functions to produce a vector of emotion scores corresponding to predefined emotion categories such as joy, amusement, anger, sadness, and neutrality.

The server trains the emotion analysis model in advance, using a dataset of labeled texts. During training, the server minimizes a loss function such as cross-entropy between predicted emotion distributions and ground-truth labels. The server performs weight updates using an optimization algorithm such as stochastic gradient descent or adaptive moment estimation. The server may apply regularization techniques such as dropout and weight decay and may perform data augmentation by perturbing or paraphrasing training sentences to increase robustness. The server stores the trained model parameters in non-volatile storage and loads them into memory at runtime.

The server applies the trained emotion analysis model to the incoming text information by performing numeric operations on the processor, including matrix multiplications, additions, and application of activation functions. The server generates emotion analysis result data consisting of emotion labels and corresponding scores. The server stores the result data as a structured object containing, for example, fields for dominant emotion, confidence scores, and auxiliary features.

The server generates evaluation information by combining the funniness level, the occurrence number data, the evaluation value, and the emotion analysis result data. The server creates numerical information fields including the weighted scores, raw counts, normalized values, and emotion intensities. The server creates category information fields including the funniness level category and one or more emotion categories. The server also associates each component of the evaluation information with identifiers that specify the underlying expressions and model versions used, which improves traceability and reproducibility. The server constructs a prompt sentence for a generative AI model. The server uses a template-driven prompt generation mechanism implemented as part of the character string processing program. The server builds a text prompt that describes the original text, the occurrence numbers of the predetermined group of expressions, the computed funniness level, and the emotion analysis result. The server also encodes generation conditions for visual feedback, including parameters for visual elements such as color scheme, size, layout, and degree of animation. The server uses deterministic string concatenation and rule-based insertion of parameter values into the prompt template to produce a coherent prompt sentence.

In one concrete example, the server constructs the following prompt sentence:

“The server has analyzed the following text: “This movie is so funny, warau w w w”.

The counts of specific expressions are: ‘warau’: 1 time, ‘w’: 3 times.

The computed funniness level is HIGH on a scale of LOW, MEDIUM, HIGH, and the dominant emotion is amusement.

Generate a visual feedback image that uses bright green colors, a large central icon indicating laughter, and a dynamic animation-like effect corresponding to a high amusement score. Provide a short English explanation that describes why the text is considered very funny.”In another example, the server constructs a prompt sentence focused on interpretation:

“Analyze the emotional tone of this text: “This movie is so funny, warau w w w”.

The server has found: ‘warau’: 1, ‘w’: 3, funniness level: HIGH, dominant emotion: amusement.

Explain in two or three English sentences how amused the user is and describe appropriate visual elements to represent this reaction.”

The server sends the constructed prompt sentence, as text data, to a generative AI model hosted either on the same server or on a remote computing resource. The server uses a generative information processing model, such as a neural network-based text-to-image model or a language model with image-parameter output, which has an architecture including an embedding encoder for the prompt, one or more transformer or convolutional blocks, and a decoder that outputs image data or image-parameter descriptions. The server controls the generative AI model by specifying parameters such as sampling temperature, number of decoding steps, and resolution. The server receives, as output, visual feedback data, which may be an image bitmap, a set of vector graphics instructions, or a structured description of visual elements.

The server stores the visual feedback data in memory and may also store it in the information storage unit for reuse or analysis. The server packages, as output data, the funniness level, the emotion analysis result data, the occurrence number data, and the visual feedback, and transmits this output data to the terminal through the communication network.

The terminal receives the output data from the server. The terminal parses the received data and displays the visual feedback on a display device, such as a liquid crystal display or organic light-emitting diode panel. The terminal displays, for example, a bar chart showing the counts for “warau” and “w”, a graphical indicator of the funniness level (such as a gauge marked at HIGH), and the image generated by the generative AI model. The terminal also displays the textual explanation generated based on the evaluation information and the emotion analysis, allowing the user to understand how the system interpreted the original text.

This configuration provides technical improvements beyond mere automation of human reading. The server reduces communication load by transmitting compact evaluation information and prompts rather than raw intermediate feature vectors or large amounts of graphical templates. The server reduces client-side processing burden because the complex natural language processing, statistical evaluation, emotion estimation, and prompt generation are executed centrally on the server. The server improves processing speed and throughput by using optimized numerical libraries and dedicated hardware resources for the neural network computations, enabling real-time or near-real-time feedback even under high load. The server improves accuracy and consistency because the funniness level and visual feedback are derived from calibrated models and stored general recognition data, rather than ad hoc client-side rules.

The server further improves computation efficiency because the integration of expression counting, statistical weighting, and emotion analysis into a unified pipeline permits reuse of intermediate representations and avoids redundant parsing and tokenization. For example, the tokenization result produced for emotion analysis is also reused for expression detection, which reduces the number of passes over the same text. The server uses compact data structures, such as index-based token arrays and integer-based occurrence counters, to minimize memory use and cache misses. These architectural choices lead to lower latency and reduced error rates in the presence of noisy user inputs.

The server employs non-conventional processing rules that differ from manual human interpretation. The server applies a specific weighting scheme and normalization function that convert discrete occurrence counts into a continuous evaluation value optimized for predictive performance on historical datasets. The server automatically adjusts thresholds based on stored general recognition distributions, which a human reader would not systematically compute. The emotion analysis neural network uses distributed representations that capture subtle correlations between expressions and reactions, and these representations are not directly interpretable by humans, providing a machine-specific processing pathway. In another embodiment, the server uses a different neural network architecture for emotion analysis, such as a convolutional network applied to character-level encoding of text, in which each character code is embedded into a vector and passed through multiple convolution and pooling layers before classification. In a further embodiment, the server uses an ensemble of models, such as combining a recurrent neural network with a transformer-based encoder, and aggregates their outputs by averaging or weighting based on validation performance. The server may also implement online learning, in which feedback from user interactions (for example, explicit ratings of whether the visual feedback matched the user's feeling) is used to update model parameters or general recognition reference data in a controlled fashion.

In an alternative embodiment, the generative AI model is configured as a text-to-parameter model rather than a full text-to-image model. The server receives from the generative AI model a specification of visual element parameters, such as color codes, shape types, layout constraints, and animation durations. The server then uses a graphics rendering engine running on the server or the terminal to produce final images. This configuration reduces the computational load on the generative AI model and allows the system to adapt to different display environments while maintaining consistent semantics of the visual feedback.

In another variation, the server supports multiple predetermined groups of expressions corresponding to different domains, such as formal language, sarcasm indicators, or domain-specific jargon. The server selects an appropriate group of expressions based on context, such as the type of application or prior behavior of the user, and uses separate general recognition datasets and coefficients for each group. This multi-domain configuration improves the robustness and versatility of the system.

The server can also operate in a batch-processing mode, where the server processes large volumes of text data, such as logs of user comments, and generates aggregated statistics and visual summaries. Even in this mode, the same pipeline of tokenization, expression detection, occurrence counting, evaluation value calculation, emotion analysis, and prompt construction is used, and the technical benefits of integrated processing, minimized redundancy, and calibrated evaluation are preserved.

By designing the system in this manner, the server implements a specific, structured data flow and a non-generic combination of algorithms that improves the technical performance of the computing environment. The server reduces latency, increases accuracy of funniness assessment, provides reproducible and calibrated visual feedback, and optimizes network usage all enabled by the coordinated use of natural language processing, machine learning-based emotion analysis, statistical weighting, and prompt-based control of a generative AI model.

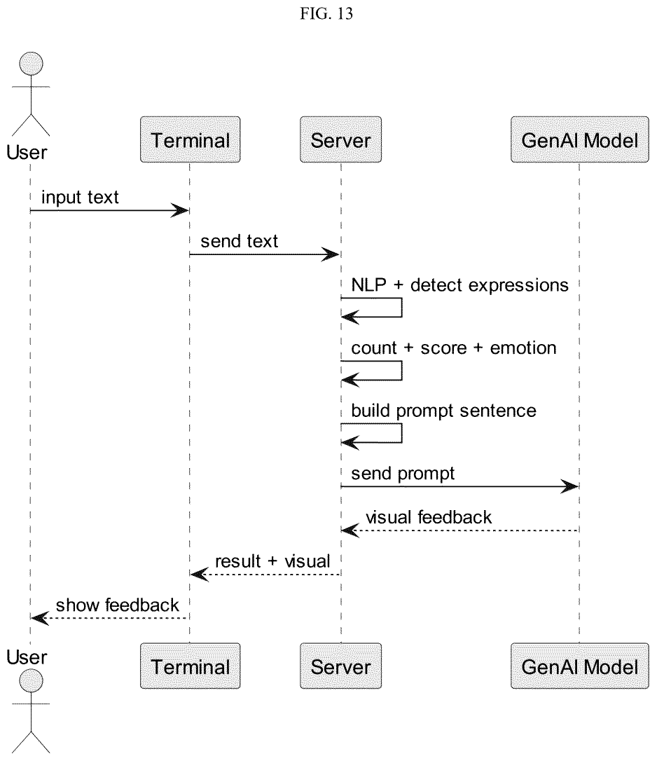

The following describes the processing flow using FIG. 13.

Step 1:

The user operates the terminal and opens an application or web page that provides a text input field.

The terminal displays the text input field and a control such as a “Analyze” button on its display.

The user inputs text information, for example “This movie is so funny, warau w w w”, using a software keyboard or a hardware keyboard.

The terminal treats the user-entered text as input, encapsulates it in a request object that includes metadata such as a timestamp and a terminal identifier, and serializes this object into text data (for example, a UTF-8 encoded string).

The terminal outputs the serialized text data by transmitting it to the server via a communication network using a protocol such as HTTPS.

Step 2:

The server receives, as input, the text data transmitted from the terminal.

The server parses the received request to extract fields including the raw text, the timestamp, and optional user or session identifiers.

The server performs validation on the raw text, such as checking character encoding, length limits, and presence of forbidden control characters, and discards or truncates invalid data.

The server writes the validated raw text into a request buffer in main memory and may log a summary record to a storage unit for later analysis.

The server outputs a normalized internal representation of the text, for example a string object and an associated metadata record, for use by subsequent processing modules.

Step 3:

The server receives, as input, the normalized text representation from Step 2.

The server invokes a natural language processing program, implemented with a language analysis library, to tokenize the text.

The server performs tokenization by scanning the text string, identifying boundaries between words, symbols, and punctuation, and creating a sequence of token objects, each containing at least a surface form and a position index.

The server may additionally assign part-of-speech tags or basic syntactic labels to each token using trained models in the NLP library.

The server outputs a token sequence data structure, such as an ordered list or array of tokens, along with the original text for use in expression detection.

Step 4:

The server receives, as input, the token sequence and the original text from Step 3.

The server loads a predetermined group of target expressions, such as “warau” and sequences of “w”, from configuration data stored in the information storage unit.

The server constructs regular expression patterns corresponding to each target expression, for example a pattern that matches one “warau” and a pattern that matches one or more consecutive “w” characters.

The server applies the regular expression engine to the original text to find all positions where each pattern matches, performing pattern-matching operations on the character string.

The server outputs an intermediate detection result that maps each target expression to a list of occurrence positions or spans (start and end indices) within the text.

Step 5:

The server receives, as input, the detection result from Step 4.

The server allocates a counting structure, such as a dictionary keyed by expression identifiers with integer counters initialized to zero.

The server iterates over each detected occurrence of each expression, increments the corresponding counter, and, if required, expands sequences (for example, treating “www” as three occurrences of “w”) by performing character-level counting.

The server aggregates these operations to produce quantitative occurrence numbers for each member of the predetermined group of expressions.

The server outputs occurrence number data, which associates each expression with its computed occurrence count and optionally with associated position lists.

Step 6:

The server receives, as input, the occurrence number data from Step 5.

The server retrieves, from the information storage unit, expression-specific coefficients and thresholds representing general recognition for each expression.

The server computes a weighted sum by multiplying each expression's occurrence count by its coefficient and summing the results, thereby generating a raw evaluation score.

The server applies a normalization function, such as scaling and clipping, to map the raw evaluation score into a defined numeric range, and then compares the normalized score against stored threshold values to classify the funniness level into categories such as LOW, MEDIUM, or HIGH.

The server outputs both the numerical evaluation value and the categorical funniness level for use in later stages.

Step 7:

The server receives, as input, the token sequence and the original text from Step 3.

The server invokes an emotion analysis program that uses a pre-trained neural network model to estimate emotion attributes from the text.

The server converts each token into a numeric embedding vector using an embedding matrix stored in memory, then passes the sequence of embedding vectors through a sequence encoder, such as a recurrent layer or a transformer layer, and finally through one or more fully connected layers to compute emotion scores.

The server calculates, for each predefined emotion category, a score representing the likelihood or intensity of that emotion by applying softmax or similar activation functions to the network output.

The server outputs emotion analysis result data that includes at least one dominant emotion label (for example, amusement) and associated numeric scores for each emotion category.

Step 8:

The server receives, as input, the evaluation value and funniness level from Step 6 and the emotion analysis result data from Step 7.

The server creates evaluation information by combining these inputs into a structured record that contains numerical information (such as counts, scores, and normalized values) and category information (such as the funniness category and emotion category).

The server associates the evaluation information with identifiers for the underlying models, parameters, and expressions to maintain traceability.

The server stores the evaluation information in memory and may also persist selected fields in the information storage unit for logging and future recalibration.

The server outputs the evaluation information as a consolidated object that can be consumed by a prompt generation module.

Step 9:

The server receives, as input, the evaluation information from Step 8 and the original text from Step 2.

The server selects a prompt template that defines the textual structure of a prompt sentence for a generative AI model, including placeholders for counts, funniness level, emotion labels, and visual element parameters.

The server fills the placeholders in the template by inserting concrete values from the evaluation information, such as “‘warau’: 1 time, ‘w’: 3 times, funniness level: HIGH, dominant emotion: amusement,” and by deriving visual parameters (for example, “bright colors,” “large central icon,” or “strong animation effect”) based on the evaluation values.

The server concatenates fixed text segments and formatted values using the character string processing program, thereby generating a coherent prompt sentence in natural language.

The server outputs prompt sentence data as a text string that encodes both the analysis results and the visual feedback generation conditions.

Step 10:

The server receives, as input, the prompt sentence data from Step 9.

The server transmits the prompt sentence to a generative AI model via an application programming interface, specifying configuration parameters such as output modality, resolution, or decoding parameters.

The server waits for the generative AI model to process the prompt sentence and to return visual feedback data, which may be an image, a set of drawing commands, or structured visual parameters.

The server validates the returned visual feedback data, for example by checking format and size constraints, and converts it into a representation suitable for delivery to the terminal (such as encoding an image into a specific file format).

The server outputs the validated visual feedback data along with the associated evaluation information for final presentation.

Step 11:

The server receives, as input, the visual feedback data from Step 10 and the evaluation information from Step 8.

The server constructs an output payload that combines the funniness level, the numeric evaluation scores, the emotion analysis result data, and the visual feedback data into a single response object.

The server serializes the response object into a transmission format, such as a structured text format with embedded binary data, and adds protocol headers indicating content type and length.

The server transmits the serialized output payload to the terminal via the communication network as a response to the previously received request.

The server outputs the response onto the network interface, thereby completing the server-side processing for the given text.

Step 12:

The terminal receives, as input, the response payload sent from the server in Step 11.

The terminal parses the payload, extracts components including the funniness level, emotion analysis results, and the visual feedback data, and stores them temporarily in memory.

The terminal decodes the visual feedback data, for example by loading an image into an in-memory image object or by interpreting visual parameters to render shapes and animations using a graphics library.

The terminal draws the visual feedback on the display, positions associated textual information such as “funniness level: HIGH” and a short explanation under or beside the image, and updates the user interface so that the user can view the result.

The terminal outputs a rendered screen that presents the generated visual feedback and associated analysis, enabling the user to perceive the system's interpretation of the original text.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented text analysis and visualization systems are limited in how they transform raw user text into machine-understandable signals and then into meaningful, real-time visual feedback. Typical sentiment analysis engines merely output coarse sentiment scores (for example, positive, negative, or neutral) and do not exploit fine-grained indicators such as slang, onomatopoeia, or reaction-specific expressions that strongly correlate with user amusement or engagement. Furthermore, known systems generally render static or weakly parameterized visuals that are not structurally tied to computed metrics such as funniness levels or evaluation levels, and that are not dynamically adjusted in accordance with emotion intensity.

From a computer technology standpoint, existing systems exhibit several technical limitations. First, they do not define an integrated processing pipeline in which a processor systematically (i) detects specific expressions at the token level, (ii) combines their occurrence statistics with machine-learned emotion levels, and (iii) converts those combined metrics into a structured prompt sentence for a generative model. As a result, the processor cannot consistently control visual density, arrangement, and color tone of generated images as functions of computed levels, which leads to non-deterministic or weakly correlated outputs. Second, conventional implementations treat generative models as opaque “black boxes,” passing free-form prompts that are not automatically derived from measured signal values. This prevents the computing system from deterministically mapping internal state (such as funniness or evaluation metrics) to external visual output and thereby limits system controllability, repeatability, and optimization.

Moreover, known architectures generally lack a dedicated mechanism by which a processor post-processes images generated by a generative model based on emotion analysis results. Without a technical linkage between emotion levels and image color parameters (for example, hue, brightness, and saturation), the system cannot adapt visual tone to reflect user emotion in a fine-grained and algorithmic manner. This absence of structured post-processing leads to additional computation, trial-and-error prompt design, and increased latency, and it hinders the ability of the computing system to provide real-time or quasi-real-time feedback in response to high-volume user inputs such as live-stream comments.

In addition, many existing systems do not exploit probabilistic techniques, such as Bayesian estimation, to robustly evaluate the occurrence frequency of specific expressions against reference distributions stored in a data repository. Without such statistical normalization and weighting, the mapping from raw frequency counts to funniness or evaluation levels is brittle, sensitive to noise, and difficult to adapt across different domains or user populations. This results in unstable behavior of the overall computing pipeline, including unstable prompts and visual outputs, and degrades the quality and reliability of the human-computer interaction.

Accordingly, there is a need for an improved computer-implemented system that, using a processor, (i) receives user character information, (ii) detects and statistically evaluates specific expressions, (iii) analyzes user emotion with machine learning, (iv) computes funniness or evaluation levels by jointly considering expression statistics and emotion levels, (v) automatically constructs structured prompt sentences that parameterize a generative model in terms of density and color tone, (vi) performs deterministic image adjustment linked to emotion categories and levels, and (vii) outputs adjusted images and associated levels as real-time or quasi-real-time visual feedback. Such a system improves the functioning of the computer by providing a technically grounded, end-to-end pipeline from raw text to controlled generative output, with defined intermediate representations and control parameters that enhance predictability, responsiveness, and expressiveness of the visual feedback generated by the computing apparatus.

The specific processing by the specific processing unit 290 of the data processing device 12 in Application Example 2 is realized by the following means.

The present invention provides a server comprising a processor and a communication interface, the processor being configured to receive character information from a user via the communication interface, convert input information into text by performing speech recognition processing when audio information is included in the character information, perform natural language processing on the character information to segment the character information into linguistic units or symbol units, detect specific expressions indicating emotion or reaction in the segmented character information by pattern matching processing or statistical language processing and calculate an occurrence frequency of the detected specific expressions, apply an emotion analysis model to the character information to calculate an emotion category and an emotion level indicating emotion strength, calculate, as a numerical value, at least one of a funniness level and an evaluation level as an evaluation index based on the occurrence frequency of the specific expressions and the emotion level, construct a structured prompt sentence in accordance with at least one of the funniness level and the evaluation level and in accordance with the emotion category and the emotion level, the prompt sentence including descriptions that specify at least one of density, arrangement, and complexity of natural objects and at least one of a bright color tone and a dark color tone, output the prompt sentence to a generative information processing model to cause the generative information processing model to generate at least one of an image simulating a natural environment and an image simulating a grass field, perform image adjustment processing on image data generated by the generative information processing model to change at least one of hue, brightness, and saturation of the image data in accordance with the emotion category and the emotion level and obtain adjusted image data, and output, via the communication interface, the adjusted image data and at least one of the funniness level and the evaluation level to cause a terminal apparatus to present the adjusted image data and the at least one of the funniness level and the evaluation level as visual feedback in real time or in quasi real time. This enables the computing system to implement a technically integrated pipeline in which detected specific expressions and machine-learned emotion levels are fused into numeric indices, encoded into structured prompt sentences that deterministically control a generative model, and further reflected in algorithmic post-processing of generated images, thereby improving controllability, stability, and responsiveness of computer-generated visual feedback in response to user text input.

The term “character information” refers to digital data representing human language content in textual form, including text directly input by a user, text obtained by converting audio input into text, and any combination of characters, symbols, and punctuation processed by the system.

The term “communication interface” refers to a hardware and/or software component that enables data exchange between the server and an external apparatus, such as a terminal device or a network node, using a communication protocol including wired or wireless communication.

The term “speech recognition processing” refers to a computational procedure that converts audio information representing spoken language into corresponding text data by using an acoustic model, a language model, or a combination thereof.

The term “natural language processing” refers to a set of computational techniques for analyzing and processing human language text, including tokenization, morphological analysis, syntactic analysis, and semantic analysis, to obtain linguistic units or features usable for subsequent processing.

The term “linguistic units” refers to elements obtained by segmenting text, including words, subwords, morphemes, phrases, or other meaningful text segments.

The term “symbol units” refers to units obtained by segmenting text into non-linguistic characters or groups of characters, such as emoticons, repeated characters, punctuation patterns, or special symbols indicative of user reactions.

The term “specific expressions” refers to particular linguistic units or symbol units, such as certain words, phrases, or character patterns, that are predefined or learned as indicators of user emotion, reaction, or amusement.

The term “pattern matching processing” refers to a computational operation for detecting specific expressions in text by comparing text segments against predefined patterns, rules, or regular expressions.

The term “statistical language processing” refers to processing that uses probabilistic or statistical models to analyze text, including frequency analysis, n-gram models, or probabilistic classifiers, for the purpose of detecting specific expressions or estimating their significance.

The term “occurrence frequency” refers to a numerical value indicating how many times a specific expression appears in a given portion of character information, optionally normalized by text length or other contextual factors.

The term “emotion analysis model” refers to a machine-learned model or algorithm configured to receive character information as input and output an emotion category and an emotion level, based on features extracted from the input.

The term “emotion category” refers to a classification label representing a type of emotional state, including categories such as joy, sadness, anger, surprise, positive, negative, or neutral, as determined by the emotion analysis model.

The term “emotion level” refers to a numerical value representing intensity or strength of an emotion category, defined on a predetermined scale and computed by the emotion analysis model or by a post-processing rule applied to a model output.

The term “funniness level” refers to a numerical index calculated from at least the occurrence frequency of specific expressions and the emotion level, representing an estimated degree of amusement or humorousness associated with the character information.

The term “evaluation level” refers to a numerical index calculated from at least the occurrence frequency of specific expressions and the emotion level, representing an overall evaluation metric such as interest, engagement, or importance associated with the character information.

The term “evaluation index” refers to a numerical measure, such as the funniness level or the evaluation level, used by the system to quantify a characteristic of the character information for subsequent control of visual feedback.

The term “information storage device” refers to a storage component, such as a memory device or a database system, configured to store reference information, parameter data, or processing results used by the processor.

The term “reference information” refers to data stored in the information storage device that represents a general recognition or baseline distribution regarding the funniness or significance of specific expressions, used for comparison with occurrence frequencies.

The term “Bayesian estimation” refers to a statistical technique in which occurrence frequencies of specific expressions are evaluated by updating prior probability distributions using observed data to obtain posterior estimates.

The term “prompt sentence” refers to a text instruction generated by the processor that encodes at least the funniness level, the evaluation level, the emotion category, and the emotion level, and that is input to a generative information processing model to control characteristics of generated output.

The term “structured prompt sentence” refers to a prompt sentence formed according to a predetermined template or rule set, in which descriptions corresponding to numeric indices, such as density and color tone, are explicitly included so that a generative model can interpret and reflect those indices.

The term “prompt sentence generation result” refers to data representing a structured prompt sentence created by the processor, including all textual elements to be provided to the generative information processing model.

The term “generative information processing model” refers to a computational model configured to generate new data, such as image data, from input conditions including a prompt sentence, by using machine learning techniques such as generative modeling.

The term “natural environment image” refers to image data representing a scene including natural objects such as grass, trees, water, sky, or terrain, generated or controlled in accordance with at least the funniness level, the evaluation level, the emotion category, or the emotion level.

The term “grass field image” refers to image data representing a scene including a field or area of grass, where the density, arrangement, or complexity of grass elements is controlled on the basis of at least the funniness level or the evaluation level.

The term “natural objects” refers to visual elements such as plants, terrain, sky, water, rocks, or other elements that compose a natural environment in the generated image.

The term “density of natural objects” refers to a parameter indicating the amount or concentration of natural objects per area within an image, which is controlled according to at least the funniness level or the evaluation level.

The term “arrangement of natural objects” refers to a pattern or spatial distribution of natural objects within an image, including clustering, spacing, or alignment, which is influenced by at least the funniness level or the evaluation level.

The term “complexity of natural objects” refers to a measure of visual or structural richness of natural objects within an image, such as variation in shapes, layers, or details, controlled in response to at least the funniness level or the evaluation level.

The term “bright color tone” refers to a set of color attributes characterized by relatively high brightness and/or saturation, used to visually represent more positive or stronger emotion categories or levels.

The term “dark color tone” refers to a set of color attributes characterized by relatively low brightness and/or reduced saturation, used to visually represent more negative or lower emotion categories or levels.

The term “image adjustment processing” refers to processing applied to image data to modify visual parameters such as hue, brightness, or saturation in a deterministic manner based on emotion-related values.

The term “hue” refers to a property of color that distinguishes one color family from another, such as red, green, or blue, and that may be shifted by the processor during image adjustment processing.

The term “brightness” refers to a property of color corresponding to perceived lightness or intensity of light, which may be increased or decreased during image adjustment processing.

The term “saturation” refers to a property of color describing its vividness or purity, which may be increased or decreased during image adjustment processing to reflect emotion levels.

The term “adjusted image data” refers to image data produced by performing image adjustment processing on image data generated by the generative information processing model, such that at least one of hue, brightness, or saturation is modified according to emotion-related parameters.

The term “terminal apparatus” refers to an external device operated by a user, such as a computing device or display device, that receives from the server the adjusted image data and index values and presents them as visual feedback.

The term “visual feedback” refers to information displayed on a terminal apparatus, including adjusted image data and numeric indices such as funniness level or evaluation level, that communicates to the user an interpretation of the character information.

The term “real time” refers to a processing and presentation mode in which visual feedback is provided with a latency sufficiently small that a user perceives the system's responses as effectively instantaneous relative to the rate of user input.

The term “quasi real time” refers to a processing and presentation mode in which visual feedback is provided with a short but non-negligible latency, sufficiently small to support interactive user experiences even if not strictly instantaneous.

In one embodiment, a server implements the present invention by executing a set of software modules on a hardware platform including at least one central processing unit (CPU), a main memory, a non-volatile storage device, a network interface controller, and, in certain configurations, a graphics processing unit (GPU). The server runs an operating system such as a general-purpose server operating system and hosts application software implemented, for example, in a high-level programming language. The server communicates with one or more terminal devices via a communication network such as the Internet or a local area network.

A terminal is a computing device such as a smartphone, tablet, personal computer, or head-mounted display. The terminal includes an input device such as a keyboard, a touch panel, or a microphone, a display device such as a liquid crystal display or an organic light-emitting display, a local processor, memory, and a network interface. The terminal executes an application or web browser that transmits character information to the server and receives visual feedback in the form of image data and numerical indicators.

A user operates the terminal to input character information. The user may type text such as comments, posts, or messages, or may speak into the microphone, in which case the terminal or the server performs speech recognition. The character information can include natural language statements, repeated symbols, and onomatopoetic expressions that indicate laughter or strong reactions. The terminal packages the character information into a data message and transmits the data message to the server via a secure communication protocol.

The server stores the received character information in a storage subsystem, such as a relational database system, together with metadata including timestamps and identifiers. The server applies natural language processing using libraries such as spaCy or NLTK to segment the character information into linguistic units and symbol units. In particular, the server tokenizes the text, assigns part-of-speech tags when applicable, and preserves repeated characters or symbol patterns as distinct tokens. The server detects specific expressions by matching tokens or token sequences against pattern rules and regular expressions that are stored in a rule repository. These specific expressions may include repeated letters, repeated punctuation, or certain words and phrases that correlate with amusement or other reactions. The server calculates an occurrence frequency for each specific expression. The server may maintain a data structure such as a hash map that maps each specific expression to a count value. The server updates this data structure as new character information is received, thereby enabling incremental aggregation across multiple messages. The server stores the occurrence frequencies and the aggregate statistics in the storage subsystem.

The server applies an emotion analysis model to the character information. In one embodiment, the emotion analysis model is implemented as a neural network configured for text classification. The neural network can have an embedding layer, one or more recurrent or transformer-based layers that process token sequences, and a fully connected output layer that outputs emotion logits. The server converts the logits into probability values for emotion categories such as joy, sadness, anger, or neutral, using, for example, a softmax function. The server defines the emotion level as a numeric value derived from the probabilities, such as a weighted sum of category indices or a scaled probability of a particular category.

The server trains the emotion analysis model offline using supervised learning. The server uses a training dataset consisting of text examples annotated with emotion labels. The server initializes model weights randomly or using pretraining, feeds batches of examples through the model, computes a loss function such as cross-entropy between the predicted probabilities and the ground-truth labels, and updates the weights using an optimization algorithm such as stochastic gradient descent or Adam. The server may perform regularization, dropout, and data augmentation techniques such as synonym replacement or random deletion to improve generalization. After training, the server deploys the trained model parameter set into the production environment and loads the parameters into memory at runtime.

For specific expressions, the server evaluates the occurrence frequency by Bayesian estimation. The server stores prior distributions for each expression in the storage subsystem, representing general recognition of funniness or importance. When the server observes new occurrence data, the server updates posterior distributions using Bayes'rule, thereby smoothing frequency estimates and reducing sensitivity to sparse data. The server calculates expectation values of posterior distributions and uses those values as normalized frequency metrics. By doing so, the server reduces noise and improves robustness of the computed funniness level or evaluation level.

The server computes at least one of a funniness level and an evaluation level based on the normalized occurrence frequencies and the emotion level. In one embodiment, the server computes the funniness level by a weighted sum of logarithmic frequency values and a function of the emotion level. The server may apply a non-linear mapping, such as a sigmoid or piecewise-linear function, to constrain the funniness level within a predefined numerical range, for example from 1 to 10. The server stores the computed levels in a structured record that also contains identifiers and time information. This structure can be implemented as a record type or as a document in a document store.

The server constructs a prompt sentence for a generative AI model based on the computed indices. A prompt sentence generation module within the server uses templates and rules to convert numeric levels into textual descriptions. The module references a configuration table that maps numeric funniness levels to qualitative descriptors such as “sparse”, “moderate”, or “very dense” for natural object density, and maps emotion categories and emotion levels to color tone descriptors such as “bright green”, “dark green”, or “desaturated colors”. The module then concatenates these descriptors into a grammatically complete prompt sentence.

For example, when the funniness level is high and the emotion category is joy with a high emotion level, the server may construct a prompt sentence such as:

“Generate an image of a grass field where the density of grass corresponds to a funniness level of 8 on a scale from 1 to 10, with very dense bright green grass under a clear sunny sky to represent strong joy.”

When the funniness level is moderate and the emotion category is neutral, the server may construct a prompt sentence such as:

“Create a natural environment scene corresponding to a funniness level of 4 and a neutral emotion level, with moderately dense grass and slightly muted green tones under a cloudy sky.”

When the funniness level is low and the emotion category is sadness, the server may construct a prompt sentence such as:

“Generate a natural environment image corresponding to a funniness level of 2 and a sadness emotion level of 5, with sparse grass, dark green colors, and an overcast sky.”

The server supplies the prompt sentence to a generative AI model. In one embodiment, the generative AI model is a diffusion-based image generation model executed on a GPU. The model receives the prompt sentence as input, encodes the words into an embedding space, and iteratively denoises a random latent tensor according to a learned denoising network. The network structure can include a sequence of convolutional layers with attention mechanisms and skip connections. The server controls inference parameters such as guidance scale, number of denoising steps, and image resolution to balance quality and latency.

The server trains the generative AI model or fine-tunes it offline using a large corpus of image-text pairs. The server defines a loss function that penalizes discrepancy between generated images and target images conditioned on text. The server updates model weights by backpropagation and batch optimization. In certain embodiments, the server uses pre-trained weights from a generic dataset and finetunes on domain-specific scenes such as grasslands or natural environments.

After the generative AI model outputs an image, the server performs image adjustment processing. The server loads the image into an image-processing module, which may utilize an image-processing library. The server computes adjustment parameters based on the emotion category and the emotion level. For example, for joy, the server may increase brightness and saturation by a factor determined by the emotion level; for sadness, the server may reduce brightness and shift hue toward cooler tones. The server applies these adjustments to each pixel by transforming color values in a color space such as HSV or HSL. This post-processing allows the server to refine visual expression in a deterministic way that reflects emotion estimates beyond what is specified in the prompt sentence.

The server outputs the adjusted image data to the terminal via the communication interface. The server may also include numeric values of the funniness level and evaluation level in the response, enabling the terminal to display both visual and numerical feedback. The terminal receives the image data, decodes it into a bitmap in memory, and renders it on the display. The terminal may show the image adjacent to the original text and present a label such as “Funniness level: 8.” This visual feedback provides an intuitive representation of user reactions.

In another embodiment, the server generates additional graphical elements such as time-series charts of funniness levels or heatmaps of reaction intensity over time. The server uses a plotting library to convert stored historical data into image-based charts. The server transmits these charts along with generated images, and the terminal displays them in a dashboard-style interface. Because the server maintains at least part of the state in structured records and updates them incrementally, the generation of charts can be done efficiently, with minimal recomputation.

The system provides technical improvements in multiple respects. By integrating Bayesian estimation with emotion-based weighting, the server reduces noise and bias in mapping raw expression frequencies to funniness levels. This improves precision and stability of the computed indices, which in turn reduces the number of trial-and-error prompt adjustments previously required by human operators. Consequently, the server decreases computation time and network usage between front-end and back-end components, because fewer iterations of request-response cycles are needed to obtain desired visuals.

By generating structured prompt sentences that encode numeric indices into explicit descriptions of visual properties, the server improves controllability of generative models, which are otherwise non-deterministic and difficult to steer. This contributes to improved computational efficiency because the generative AI model is less likely to produce irrelevant or low-quality outputs that would have to be discarded and regenerated. In addition, by decoupling frequency analysis, emotion analysis, prompt generation, and image adjustment into modular components with defined interfaces, the server enhances data management and enables reuse of intermediate results, such as cached emotion scores or funniness levels, across multiple image generations.

The server also improves communication efficiency. By computing compact scalar indices (funniness level and emotion level) and using them as control variables, the server avoids transmitting large volumes of raw textual or intermediate data to external services. The generative AI model can be executed locally, and even when executed remotely, only a limited prompt sentence and control parameters need to be sent. This design reduces network bandwidth usage and latency, enabling real-time or quasi-real-time performance even during high comment throughput situations such as live streaming.

The server conducts processing in a manner that is not a mere automation of human mental judgment. Humans can interpret text and imagine images, but they typically cannot perform multi-stage Bayesian normalization of high-volume expression statistics, high-dimensional neural emotion classification, and parametric control of generative model latent spaces in real time. The system applies specific algorithms and internal representations that differ from human reasoning, such as neural embeddings, gradient-based optimization, and color space transformations, thereby improving computer technology itself rather than simply encoding human decision rules.

In still another embodiment, the server varies the architecture of the emotion analysis model. For shorter texts, the server may use a convolutional neural network with temporal convolution layers over token embeddings; for longer texts, the server may use a transformer architecture with multi-head self-attention. The server chooses an architecture based on predicted text length or complexity, which optimizes accuracy and resource usage. The server can store multiple trained model instances and select one dynamically, thereby adapting computation to the input characteristics.

In yet another embodiment, the server uses a rule-based pre-processor that filters specific patterns before passing text to the neural model. For example, the server may compress repeated characters into a count value and feed this count as an additional numeric feature directly into the neural network along with embedded tokens. This non-traditional feature design provides the model with explicit information about repetition intensity, improving its ability to discriminate between mild and strong reactions. Experimental evaluation can show that including these features reduces classification error rates and increases correlation between computed funniness levels and user-perceived funniness.

The server can also adapt to different languages and cultural contexts by maintaining separate sets of specific expressions, prior distributions, and prompt templates. The server may store these sets in configuration tables indexed by locale codes or platform identifiers. When a request is received, the server selects the appropriate configuration and applies it to the processing pipeline. This modular design allows a single server implementation to service multiple use cases while preserving the core technical benefits of structured prompt control and emotion-linked image adjustment.

In an alternative embodiment, the terminal performs some preprocessing steps, such as initial tokenization or on-device speech recognition, using its own processor. The terminal then transmits partially processed data to the server. This reduces server load and network transfer of raw audio, lowering latency and resource consumption. The server still performs core tasks of Bayesian frequency analysis, neural emotion classification, prompt generation, and image adjustment, ensuring that the technical improvements in computability and control are retained.

Through these embodiments, the server, the terminal, and the user cooperate to implement a concrete, reproducible system that transforms raw character information into structured internal metrics and controlled visual feedback. The detailed data structures, algorithms, and model architectures disclosed herein support implementation by a person skilled in the art and demonstrate that the invention constitutes a specific improvement in computer-based processing of emotional reaction data and generative image control, rather than an abstract idea detached from technological application.

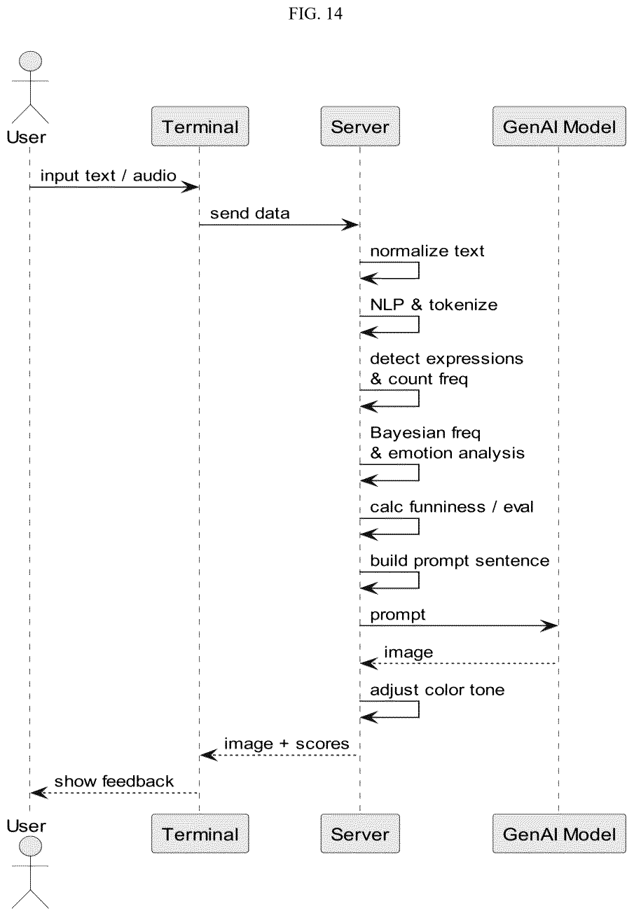

The following describes the processing flow using FIG. 14.

Step 1:

The user inputs character information on the terminal.

The user types a text message or speaks into a microphone in an application or web browser running on the terminal. The terminal receives the input via an input device such as a keyboard, touch panel, or microphone.

Input: raw user input (text string or audio signal).

Output: character information packaged in a data structure (for text, a UTF-8 string; for audio, an audio file or audio buffer plus metadata).

Step 2:

The terminal transmits the character information to the server.

The terminal encapsulates the character information and associated metadata (for example, user ID, timestamp, language code) into a request message and sends the request to the server via a communication protocol such as HTTPS.

Input: character information and metadata on the terminal.

Output: a network request containing the character information and metadata delivered to the server.

Step 3:

The server receives and normalizes the character information.

The server uses a communication interface to accept the incoming request and parses the payload to extract the character information and metadata. When audio information is included, the server performs speech recognition processing using an automatic speech recognition component to convert the audio signal into text. The server then stores the normalized text and metadata in a storage subsystem.

Input: request message from the terminal containing text or audio.

Output: normalized text string and associated metadata stored in memory or a database.

Step 4:

The server performs natural language processing and tokenization.

The server applies a natural language processing library to the normalized text to segment the text into linguistic units and symbol units. The server carries out tokenization, part-of-speech tagging if applicable, and special handling of repeated characters and symbols so that expressions such as repeated letters or repeated punctuation remain distinguishable.

Input: normalized text string.

Output: a token sequence data structure representing linguistic units and symbol units with attributes (for example, token type, position, repetition count).

Step 5:

The server detects specific expressions and computes occurrence frequencies.

The server checks the token sequence against a set of predefined pattern rules and regular expressions corresponding to specific expressions that indicate emotion or reaction. The server increments counters in a frequency map for each detected specific expression. The server may also aggregate counts across multiple messages for the same context (for example, same live stream or same session).

Input: token sequence data structure.

Output: a frequency map associating each specific expression with an occurrence count and optionally aggregated statistics such as total counts and time-based counts.

Step 6:

The server applies Bayesian estimation to evaluate expression frequencies.

The server retrieves prior distribution parameters for each specific expression from an information storage device. The server combines the prior parameters with the observed occurrence counts using Bayes'rule to compute posterior distribution parameters. The server then calculates expected values or other summary statistics from the posterior distributions to obtain normalized frequency metrics that are less sensitive to noise.

Input: occurrence counts for specific expressions and prior distribution parameters from storage.

Output: normalized frequency metrics for each specific expression stored in a normalized frequency vector.

Step 7:

The server performs emotion analysis and computes an emotion level.

The server feeds the normalized text into an emotion analysis model, which is implemented as a trained neural network. The model transforms tokens into embeddings, processes them through internal layers, and outputs logits for emotion categories. The server converts the logits to probabilities via a softmax function and determines an emotion category and an emotion level based on these probabilities. The server may compute the emotion level as a continuous value by weighting category indices with their probabilities.

Input: normalized text string and tokenized representation.

Output: an emotion category label and an emotion level value stored in an emotion result record.

Step 8:

The server calculates a funniness level and/or an evaluation level.

The server combines the normalized frequency metrics and the emotion level by applying a predefined mathematical function. For example, the server may compute a base score from the logarithm of frequency metrics and then adjust the base score according to the emotion level by applying a weight factor. The server clamps the result to a predefined numeric range to produce a stable funniness level or evaluation level.

Input: normalized frequency vector and emotion result record.

Output: at least one numerical index, including a funniness level and/or an evaluation level, stored in an index record.

Step 9:

The server generates a structured prompt sentence for a generative AI model.

The server references configuration tables that map ranges of funniness levels and evaluation levels to textual descriptors of natural object density, arrangement, and complexity, and that map emotion categories and emotion levels to descriptors of color tone such as bright or dark. The server fills a template using these descriptors and the numeric indices to create a structured prompt sentence.

Input: index record containing the funniness level and/or evaluation level, and emotion result record.

Output: a structured prompt sentence string describing desired visual properties for input to the generative AI model.

Step 10:

The server invokes the generative AI model using the prompt sentence.

The server passes the prompt sentence and generation parameters (for example, image size, guidance scale, number of inference steps) to a generative AI model such as a diffusion-based image generator. The model encodes the text, iteratively transforms a random latent tensor, and produces image data that conforms to the conditions described in the prompt sentence. The server receives the generated image data from the model.

Input: structured prompt sentence and generation parameters.

Output: raw generated image data representing at least one of a natural environment image or a grass field image.

Step 11:

The server performs image adjustment processing based on the emotion result.

The server loads the generated image data into an image-processing module and converts the color representation into a color space suitable for adjustment. The server determines adjustment parameters such as hue shift, brightness scaling, and saturation scaling from the emotion category and emotion level. The server applies these adjustments pixel-wise or region-wise, thereby obtaining adjusted image data whose color tone reflects the emotion result.

Input: raw generated image data and emotion result record.

Output: adjusted image data with modified hue, brightness, and/or saturation stored in an image buffer.

Step 12:

The server prepares response data containing visual feedback.

The server constructs a response message that includes the adjusted image data and associated indices such as the funniness level and evaluation level. The server may encode the image in a compressed format and may include additional metadata such as timestamps or identifiers. The server then transmits the response message to the terminal via the communication interface.

Input: adjusted image buffer and index record.

Output: a network response containing the adjusted image and numeric indices delivered to the terminal.

Step 13:

The terminal receives and renders the visual feedback.

The terminal accepts the response from the server, decodes the image data into a drawable bitmap, and reads the numeric indices. The terminal then displays the image on the display device and may present text labels or graphical indicators showing the funniness level or evaluation level next to the image and the original user text.

Input: response message containing adjusted image data and indices.

Output: a rendered visual feedback screen presented to the user on the terminal display.

Step 14:

The user observes the feedback and may provide further input.

The user views the generated image, its color tone, and the displayed funniness or evaluation levels to understand how the system interpreted the character information. Based on this feedback, the user may decide to input additional text or modify subsequent messages, thereby initiating another cycle of processing.

Input: visual feedback displayed on the terminal.

Output: optional new user input that can be processed again starting from Step 1.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

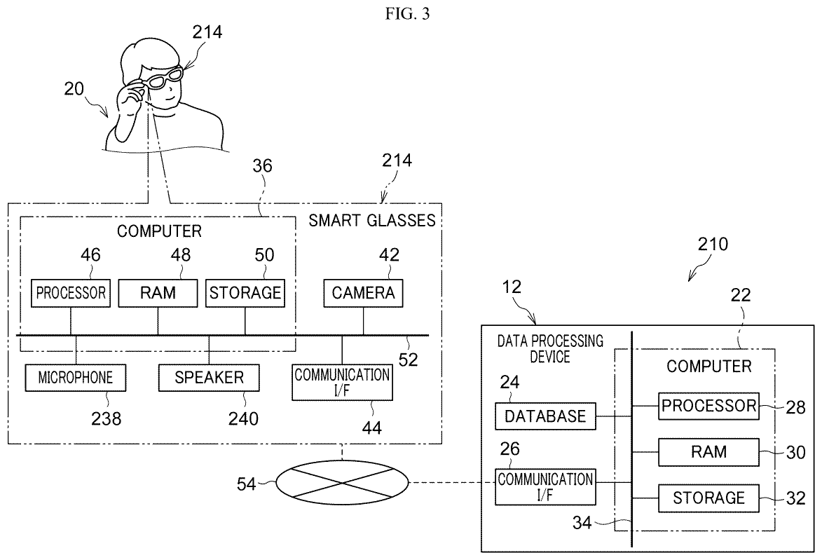

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

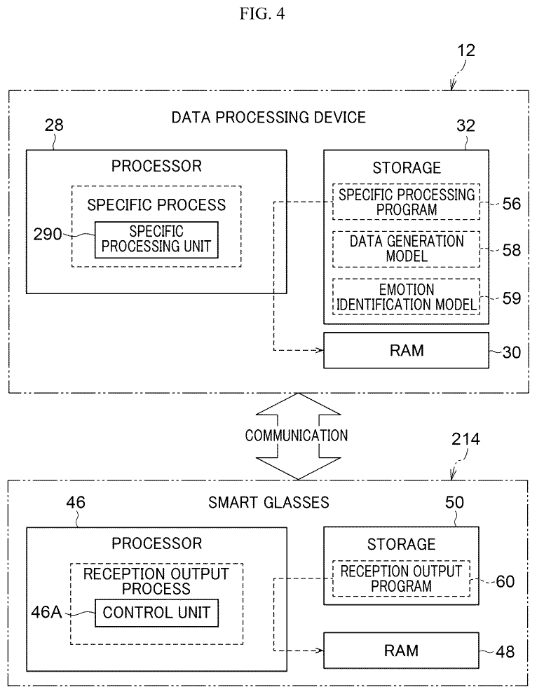

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

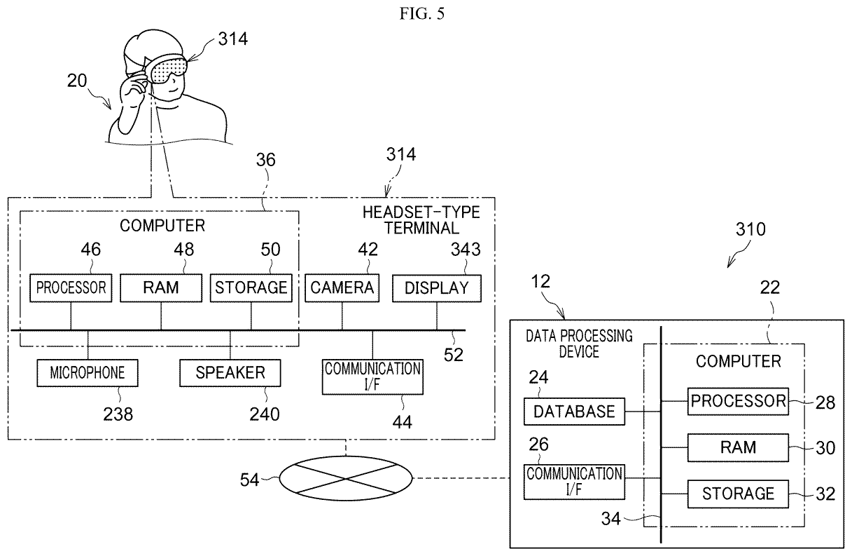

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

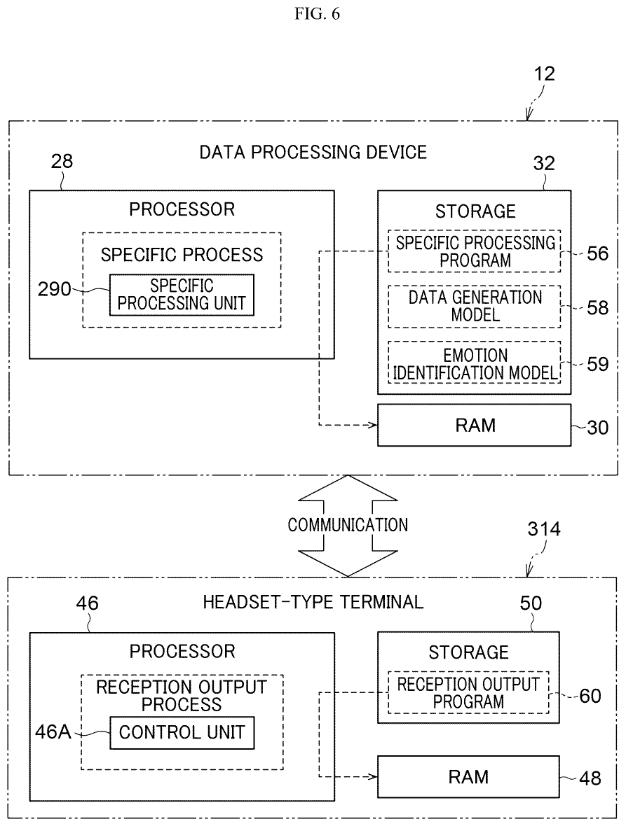

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

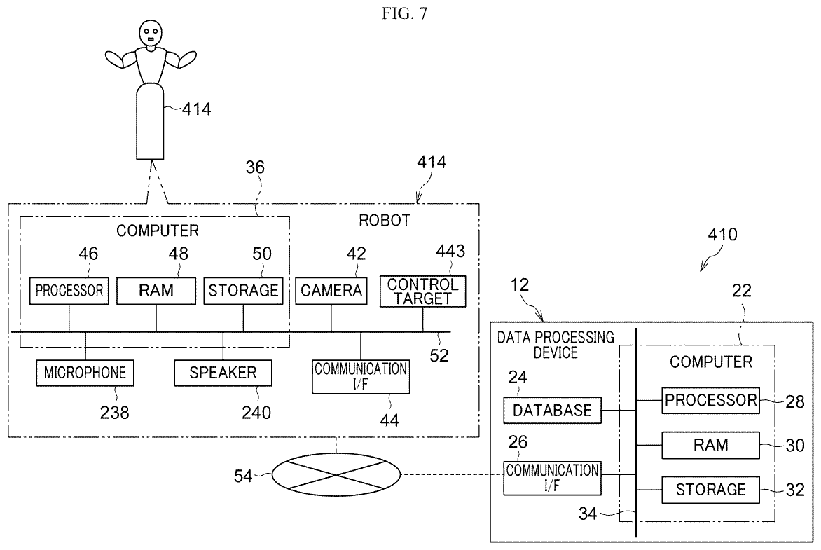

FIG. 7 illustrates an example of a configuration of a data processing system 410 according to a fourth exemplary embodiment.

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

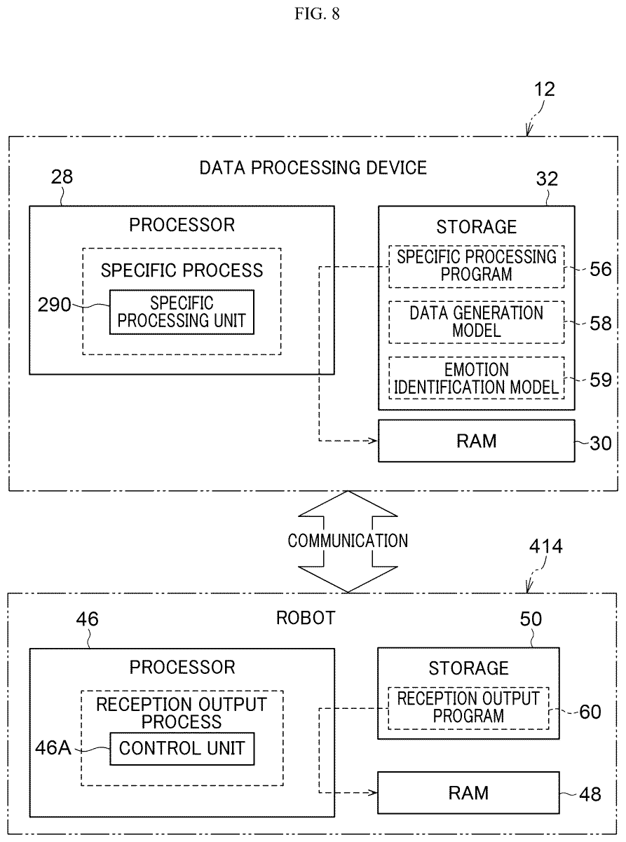

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

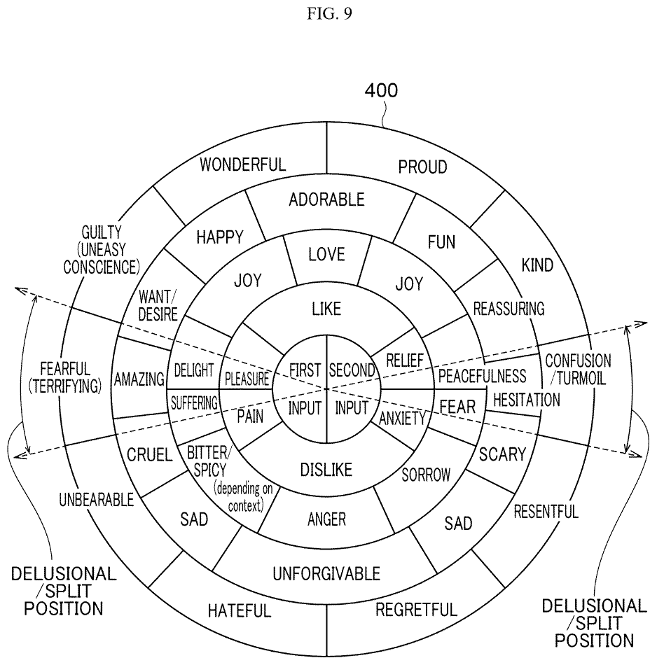

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

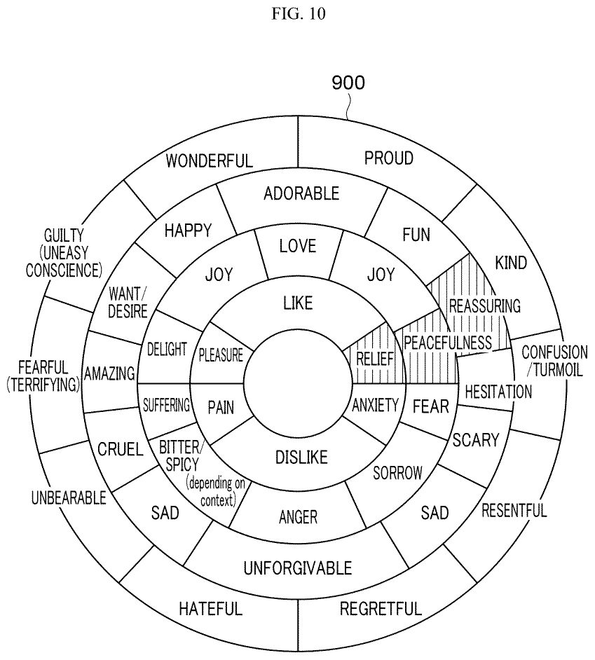

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,

wherein the processor is configured to receive, via an interface with a terminal including a display device and an input device, text information including source conditions from a user, wherein the processor is configured to acquire, based on the source conditions and via an information communication network, structured document data and posting data from a plurality of information providing apparatuses, extract standardized text data from the structured document data, and integrate the standardized text data with the posting data and text data directly input by the user to generate analysis target text data,

wherein the processor is configured to perform natural language processing on the analysis target text data, the natural language processing including morphological analysis, phrase segmentation, and statistical quantity calculation, to extract important phrases and important sentences and to generate summary information of the analysis target text data,

wherein the processor is configured to determine abstract topic information representing a content of a subject and a target reader attribute based on the important phrases and the summary information, and to automatically generate at least one prompt sentence for input to a generative AI model by using a plurality of template sentence patterns including the topic information, and

wherein the processor is configured to transmit the summary information, the important phrases, and the prompt sentence to the terminal so that the terminal visually presents the summary information, the important phrases, and the prompt sentence to the user.

### (Supplementary 2)

The system according to supplementary 1,

wherein the processor is configured to convert a plurality of documents included in the analysis target text data into vector representations as a corpus, calculate a weight score of each phrase based on a statistical model, extract a set of important phrases including compound phrases, and perform hierarchical classification of the topic information based on the set of important phrases.

### (Supplementary 3)

The system according to supplementary 1,

wherein the processor is configured to generate, as the prompt sentence, at least one prompt sentence classified into one of an explanation request type, a summarization request type, a comparison request type, or a risk analysis request type in accordance with the topic information and an occurrence tendency of the important phrases, and to present a group of candidate prompt sentences to the user such that the user can select and edit the candidate prompt sentences on the terminal.

### Application Example 1

### (Supplementary 1)

A system comprising a processor,

wherein the processor is configured to

acquire, via a communication function of an information providing apparatus, content information including text information related to a user from an external information processing apparatus, the content information including at least one piece of user-related text information,

analyze the text information included in the acquired content information by using a language processing apparatus that is capable of executing natural language processing, detect specific expressions contained in the text information, and calculate an interest level representing a degree of interest of the user on a topic on the basis of an occurrence frequency of the specific expressions,

generate, on the basis of the interest level and topic information associated with the specific expressions, a prompt sentence including prompt sentence generation instruction information for causing a generative AI model as a generative information generation apparatus to generate advertising information, the prompt sentence including at least one instruction related to personalization of advertising content according to the interest level,

generate advertisement display control information for outputting, to a terminal apparatus, the advertising information generated by the generative AI model on the basis of the generated prompt sentence, and

cause, on the basis of the advertisement display control information, a display apparatus of the terminal apparatus to display personalized advertising information according to the interest level of the user.

### (Supplementary 2)

The system according to supplementary 1,

wherein the processor is configured to

evaluate the occurrence frequency of the specific expressions contained in the content information by a statistical estimation technique, perform normalization processing and weighting processing for each topic associated with the specific expressions, calculate the interest level as a numerical index, store the numerical index as user profile information in a storage apparatus, and dynamically select topic information and expression content to be included in the prompt sentence on the basis of the user profile information.

### (Supplementary 3)

The system according to supplementary 1,

wherein the processor is configured to

acquire user operation information and response information to the advertising information from the terminal apparatus, analyze the user operation information and the response information, reflect an analysis result in recalculation of the interest level, regenerate the prompt sentence to be supplied to the generative AI model on the basis of an updated interest level, and provide updated advertising information to the terminal apparatus in real time or quasi real time on the basis of the regenerated prompt sentence.

### Example 2

### (Supplementary 1)

A system comprising a processor,

wherein the processor is configured to

receive text information as text data input from a user terminal via a communication network, perform language analysis including tokenization on the text information by using a character string processing program and a natural language processing program, and detect a predetermined group of expressions included in the text information,

calculate an occurrence number for each expression of the predetermined group of expressions by using regular expression processing and character string arithmetic processing, and generate occurrence number data for each expression,

calculate an evaluation value for the occurrence number data by performing statistical processing using a coefficient and a threshold defined for each expression, and determine a funniness level classified into a predetermined category based on the evaluation value, analyze an emotional expression included in the text information by using an emotion analysis program based on a machine learning algorithm, and generate emotion analysis result data,

generate evaluation information including numerical information and category information reflecting the occurrence number of the predetermined group of expressions and a general recognition thereof, based on the funniness level and the emotion analysis result data, construct a prompt sentence including an explanatory sentence describing the evaluation information and generation conditions of visual feedback, and generate prompt sentence data for instructing a generative information processing model to generate the visual feedback, and

transmit, as output data, the funniness level, the emotion analysis result data, and the visual feedback generated by the generative information processing model to the user terminal.

### (Supplementary 2)

The system according to supplementary 1,

wherein the processor is configured to

apply statistical estimation processing to the occurrence number of the predetermined group of expressions, collate the occurrence number with evaluation reference information acquired from an information storage unit that stores a general recognition regarding the predetermined group of expressions, and determine the funniness level by performing weighting processing based on the emotion analysis result data.

### (Supplementary 3)

The system according to supplementary 1,

wherein the processor is configured to

generate the prompt sentence data such that an instruction content for dynamically changing parameters of visual elements including color tone, shape, size, layout, and animation effect, in accordance with the funniness level, the emotion analysis result data, and the occurrence number data, is included in the prompt sentence data, and output, in real time, a generation result of the visual feedback generated by the generative information processing model to the user terminal.

### Application Example 2

### (Supplementary 1)

A system comprising a processor,

wherein the processor is configured to

receive character information from a user via a communication interface,

convert input information into text by performing speech recognition processing when audio information is included in the character information, and perform natural language processing to segment the character information into linguistic units or symbol units,

detect specific expressions indicating emotion or reaction in the segmented character information by pattern matching processing or statistical language processing, and calculate an occurrence frequency of the detected specific expressions,

apply an emotion analysis model to the character information to calculate an emotion category and an emotion level indicating emotion strength,

calculate, as a numerical value, at least one of a funniness level and an evaluation level as an evaluation index based on the occurrence frequency of the specific expressions and the emotion level,

generate a prompt sentence generation result by constructing a prompt sentence, in accordance with at least one of the funniness level and the evaluation level and in accordance with the emotion category and the emotion level, the prompt sentence being for causing a generative information processing model to generate at least one of an image simulating a natural environment and an image simulating a grass field, and by instructing input of the prompt sentence to the generative information processing model,

perform image adjustment processing on image data generated by the generative information processing model to change at least one of hue, brightness, and saturation of the image data in accordance with the emotion category and the emotion level, and obtain adjusted image data, and

output, via the communication interface, the adjusted image data and at least one of the funniness level and the evaluation level, to cause a terminal apparatus to present the adjusted image data and the at least one of the funniness level and the evaluation level as visual feedback in real time or in quasi real time.

### (Supplementary 2)

The system according to supplementary 1,

wherein the processor is configured to

evaluate the occurrence frequency of the specific expressions by Bayesian estimation, acquire reference information representing a general recognition regarding funniness of the specific expressions from an information storage device, compare the occurrence frequency with the reference information, and calculate at least one of the funniness level and the evaluation level by performing weighted calculation based on a deviation from the reference information and the emotion level.

### (Supplementary 3)

The system according to supplementary 1,

wherein the processor is configured to

control a content of the prompt sentence such that the prompt sentence includes a description indicating at least one of density, arrangement, and complexity of natural objects in accordance with at least one of the funniness level and the evaluation level, and includes a description indicating at least one of a bright color tone and a dark color tone in accordance with the emotion category and the emotion level, thereby causing the generative information processing model to dynamically adjust visual elements of a generated image and to enable visual feedback based on the generated image to be continuously updated and displayed to the user.

What is claimed is:

1. A system comprising:
circuitry configured to:
receive, via a communication interface coupled to a packet-switched network, text data from a terminal device;
acquire, based on source condition data included in the text data and via the communication interface, structured document data and posting data from a plurality of data sources, extract standardized text data from the structured document data, and integrate the standardized text data with the posting data and text data input by a user to generate analysis-target text data;
apply a natural language processing algorithm to the analysis-target text data comprising morphological analysis, phrase segmentation, vectorization, and statistical quantity computation, to extract important phrases and important sentences and generate summary data;
determine topic data representing a content subject and target attribute data based on the important phrases and the summary data, hierarchically classify the topic data based on a set of important phrases including compound phrases, and automatically generate at least one prompt sentence using a plurality of template sentence patterns categorized into at least an explanation request type, a summarization request type, a comparison request type, and a risk analysis request type; and
apply a machine learning algorithm to the analysis-target text data to compute an emotion state parameter, compute a response-tendency metric by analyzing occurrence frequencies of specific expressions using a statistical algorithm, and generate a visual-feedback prompt sentence for a generative neural network model based on the response-tendency metric and the emotion state parameter.

2. The system according to claim 1, wherein the circuitry is configured to evaluate the occurrence frequencies of the specific expressions using a Bayesian estimation algorithm, retrieve, from a data store, reference frequency data representing population-level occurrence tendencies for the specific expressions, compare the retrieved reference frequency data with the evaluated occurrence frequencies, and compute the response-tendency metric by weighting the emotion state parameter in combination with the comparison result.

3. The system according to claim 2, wherein the circuitry is configured to apply a morphological analysis algorithm to the analysis-target text data to segment the text into morpheme sequences, apply a vectorization algorithm to the morpheme sequences to generate embedding vectors, compute pairwise similarity scores between the embedding vectors, and extract important phrases based on a similarity threshold applied to the pairwise similarity scores.

4. The system according to claim 3, wherein the circuitry is configured to apply a phrase segmentation algorithm to the extracted important phrases to identify compound phrases, construct a hierarchical topic structure by grouping compound phrases under parent topic nodes based on semantic similarity, and store the hierarchical topic structure as a machine-readable data structure.

5. The system according to claim 4, wherein the circuitry is configured to select a prompt template from the plurality of template sentence patterns based on an occurrence tendency of the important phrases, substitute the topic data and target attribute data into the selected prompt template, and generate a candidate prompt sentence for input to a generative neural network model.

6. The system according to claim 5, wherein the circuitry is configured to generate a plurality of candidate prompt sentences by applying each of the plurality of template sentence patterns to the topic data, transmit a group of candidate prompt sentences together with the summary data and the important phrases to the terminal device, and receive a selection input and edit data from the terminal device indicating a user-selected and user-edited prompt sentence.

7. The system according to claim 6, wherein the circuitry is configured to input the user-selected and user-edited prompt sentence to a generative neural network model, receive generated output data from the generative neural network model, and transmit the generated output data to the terminal device for display.

8. The system according to claim 7, wherein the circuitry is configured to receive implicit feedback data from the terminal device indicating user interaction with the generated output data, update the template sentence patterns or the occurrence tendency weights based on the implicit feedback data, and apply the updated template sentence patterns or occurrence tendency weights in subsequent prompt sentence generation.

9. The system according to claim 1, wherein the circuitry is configured to input the visual-feedback prompt sentence to a generative neural network model specifying instructions to generate visual content data with visual element parameters adjusted based on the response-tendency metric and the emotion state parameter, receive the visual content data from the generative neural network model, and transmit the visual content data to the terminal device in real time.

10. The system according to claim 9, wherein the circuitry is configured to detect a change in the emotion state parameter exceeding a state-change threshold between consecutive processing cycles, regenerate the visual-feedback prompt sentence incorporating the updated emotion state parameter, and supply the regenerated visual-feedback prompt sentence to the generative neural network model to update the visual content data.

11. The system according to claim 1, wherein the circuitry is configured to apply a risk analysis template sentence pattern to the topic data to generate a risk analysis prompt sentence, input the risk analysis prompt sentence to a generative neural network model, and receive risk-assessment output data identifying potential risk factors associated with the topic data.

12. The system according to claim 11, wherein the circuitry is configured to compare the risk-assessment output data against a risk threshold stored in the storage device, generate a risk-alert notification when the risk-assessment output data exceeds the risk threshold, and transmit the risk-alert notification to the terminal device.

13. The system according to claim 1, wherein the circuitry is configured to store the generated analysis-target text data, the extracted important phrases, the summary data, and the topic data in a storage device indexed by a session identifier and a timestamp, and supply stored data from prior sessions as context data in subsequent processing cycles.

14. The system according to claim 13, wherein the circuitry is configured to apply a relevance-filtering algorithm to the stored data to select a subset most relevant to a current analysis request, incorporate only the selected subset as context data in a subsequent prompt sentence, and limit the context data to a predetermined token budget.

15. The system according to claim 1, wherein the circuitry is configured to apply a deduplication algorithm to the structured document data and the posting data acquired from the plurality of data sources to remove redundant content, and generate the analysis-target text data from the deduplicated content.

16. The system according to claim 1, wherein the circuitry is configured to compute a statistical distribution of occurrence frequencies of the specific expressions across the analysis-target text data, generate a histogram representation of the statistical distribution, and incorporate the histogram representation as a visualization element in the visual content data transmitted to the terminal device.

17. The system according to claim 1, wherein the circuitry is configured to apply a comparison template sentence pattern to a plurality of topic data items to generate a comparison prompt sentence, input the comparison prompt sentence to a generative neural network model, and receive comparison output data identifying similarities and differences among the plurality of topic data items for transmission to the terminal device.

18. A system comprising:
circuitry configured to:
receive, via a communication interface coupled to a packet-switched network, text data from a terminal device, and acquire structured document data and posting data from a plurality of data sources based on source condition data included in the text data;
apply a natural language processing algorithm comprising morphological analysis, phrase segmentation, vectorization, and statistical quantity computation to generate important phrases, summary data, and topic data from integrated analysis-target text data;
automatically generate at least one prompt sentence using template sentence patterns categorized into at least an explanation request type, a summarization request type, a comparison request type, and a risk analysis request type, based on the topic data and occurrence tendencies of the important phrases; and
compute an emotion state parameter using a machine learning algorithm and a response-tendency metric using a statistical algorithm, generate a visual-feedback prompt sentence based on the response-tendency metric and the emotion state parameter, and input the visual-feedback prompt sentence to a generative neural network model to obtain visual content data for transmission to the terminal device.

19. The system according to claim 18, wherein the circuitry is configured to transmit a group of candidate prompt sentences together with the summary data and the important phrases to the terminal device, receive a selection input and edit data from the terminal device, and input a user-selected and user-edited prompt sentence to the generative neural network model.

20. A method performed by circuitry, the method comprising:
receiving, via a communication interface coupled to a packet-switched network, text data from a terminal device;
acquiring, based on source condition data included in the text data and via the communication interface, structured document data and posting data from a plurality of data sources, extracting standardized text data from the structured document data, and integrating the standardized text data with the posting data and text data input by a user to generate analysis-target text data;
applying a natural language processing algorithm to the analysis-target text data comprising morphological analysis, phrase segmentation, vectorization, and statistical quantity computation, to extract important phrases and important sentences and generate summary data;
determining topic data representing a content subject and target attribute data based on the important phrases and the summary data, hierarchically classifying the topic data based on a set of important phrases including compound phrases, and automatically generating at least one prompt sentence using a plurality of template sentence patterns categorized into at least an explanation request type, a summarization request type, a comparison request type, and a risk analysis request type; and
applying a machine learning algorithm to the analysis-target text data to compute an emotion state parameter, computing a response-tendency metric by analyzing occurrence frequencies of specific expressions using a statistical algorithm, and generating a visual-feedback prompt sentence for a generative neural network model based on the response-tendency metric and the emotion state parameter.
